(19) United States
(12) Patent Application Publication
(10) Pub. No.: US 2026/0231287 A1
(43) Pub. Date: Aug. 6, 2026

(54) JOINT RESOURCE ALLOCATION FOR UE POWER SAVINGS IN JCS

(71) Applicant: QUALCOMM Incorporated, San Diego, CA (US)

(72) Inventors: Yuwei REN, Beijing (CN); Weimin DUAN, San Diego, CA (US); Hyojin LEE, San Diego, CA (US); Huilin XU, Beijing (CN)

(21) Appl. No.: 19/152,352

(22) PCT Filed: Apr. 4, 2023
(86) PCT No.: PCT/CN2023/086160

§ 371 Date: Jul. 30, 2025

(51) Int. Cl. H04W 76/28; H04W 52/02

(52) U.S. Cl. CPC H04W 76/28; H04W 52/0216

(57) ABSTRACT

Apparatuses and methods for joint resource allocation for UE power savings in JCS are described. An apparatus is configured to receive, from a network node, an indication of a sensing pattern configuration. The sensing pattern configuration is associated with a sensing resource, and includes an offset window, and is further associated with a first association of a network node DRX pattern with a UE DRX pattern, or a second association of the network node DRX pattern with data communications. The apparatus is also configured to activate the sensing resource at an activation time for a sensing occasion after a start of the offset window. The offset window corresponds to an end of an active duration at the UE prior to a start of a next sensing occasion, a start of the active duration at the UE after a prior sensing occasion, and/or a data communication.

### TECHNICAL FIELD

The present disclosure relates generally to communication systems, and more particularly, to wireless communications utilizing sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to receive, from a network node, an indication of a sensing pattern configuration, where the sensing pattern configuration is associated with a sensing resource and includes an offset window, where the sensing pattern configuration is further associated with (1) a first association of a first discontinuous reception (DRX) pattern of the network node with a second DRX pattern of a user equipment (UE), or (2) a second association of the first DRX pattern of the network node with data communications. The apparatus is also configured to activate the sensing resource at an activation time for a sensing occasion after a start of the offset window, where the offset window corresponds to at least one of (1) a first end of an active duration at the UE prior to a first start of a next sensing occasion, (2) a second start of the active duration at the UE after a prior sensing occasion, or (3) a data communication.

In the aspect, the method includes receiving, from a network node, an indication of a sensing pattern configuration, where the sensing pattern configuration is associated with a sensing resource and includes an offset window, where the sensing pattern configuration is further associated with (1) a first association of a first discontinuous reception (DRX) pattern of the network node with a second DRX pattern of the UE, or (2) a second association of the first DRX pattern of the network node with data communications. The method also includes activating the sensing resource at an activation time for a sensing occasion after a start of the offset window, where the offset window corresponds to at least one of (1) a first end of an active duration at the UE prior to a first start of a next sensing occasion, (2) a second start of the active duration at the UE after a prior sensing occasion, or (3) a data communication.

In another aspect of the disclosure, a method, a computer-readable medium, and an apparatus are provided. The apparatus is configured to configure a sensing pattern configuration for a user equipment (UE), where the sensing pattern configuration is associated with a sensing resource for a sensing occasion and includes an offset window, where the sensing pattern configuration is further associated with (1) a first association of a first discontinuous reception (DRX) pattern of the network node with a second DRX pattern of the UE, or (2) a second association of the first DRX pattern of the network node with data communications, and where the offset window corresponds to at least one of (1) an end of an active duration for the UE prior to a first start of a next sensing occasion, (2) a second start of the active duration for the UE after a prior sensing occasion, or (3) a data communication. The apparatus is also configured to transmit, for the UE, an indication of the sensing pattern configuration.

In the aspect, the method includes configuring a sensing pattern configuration for a user equipment (UE), where the sensing pattern configuration is associated with a sensing resource for a sensing occasion and includes an offset window, where the sensing pattern configuration is further associated with (1) a first association of a first discontinuous reception (DRX) pattern of the network node with a second DRX pattern of the UE, or (2) a second association of the first DRX pattern of the network node with data communications, and where the offset window corresponds to at least one of (1) an end of an active duration for the UE prior to a first start of a next sensing occasion, (2) a second start of the active duration for the UE after a prior sensing occasion, or (3) a data communication. The method also includes transmitting, for the UE, an indication of the sensing pattern configuration.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating examples of radio frequency (RF) sensing configurations and extended reality (XR), in accordance with various aspects of the present disclosure.

FIG. 6 is a diagram illustrating example XR traffic, in accordance with various aspects of the present disclosure.

FIG. 7 is a diagram illustrating examples of discontinuous reception (DRX), XR, and joint communication-sensing (JCS), in accordance with various aspects of the present disclosure.

FIG. 8 is a call flow diagram for wireless communications, in accordance with various aspects of the present disclosure.

FIG. 9 is a diagram illustrating examples of DRX patterns and sensing configurations, in accordance with various aspects of the present disclosure.

FIG. 10 is a diagram illustrating examples of DRX patterns and sensing configurations, in accordance with various aspects of the present disclosure.

FIG. 11 is a diagram illustrating examples of DRX/XR patterns with bistatic and monostatic sensing configurations, in accordance with various aspects of the present disclosure.

FIG. 12 is a diagram illustrating examples of DRX/XR patterns and sensing configurations, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a flowchart of a method of wireless communication, in accordance with various aspects of the present disclosure.

FIG. 17 is a diagram illustrating an example of a hardware implementation for an example apparatus and/or network entity.

FIG. 18 is a diagram illustrating an example of a hardware implementation for an example network entity.

### DETAILED DESCRIPTION

Wireless communication networks, such as a 5G NR network, may enable traffic flows with specific characteristics and that utilize communications and sensing for applications. Traffic flows may have various characteristics in wireless communication networks, e.g., including layer attributes, timeframes for latency, etc. As an example, extended reality (XR) traffic for UL and DL may have characteristics such as application layer attributes, short timeframes for exchange where longer latency for traffic flows may reduce a user experience with an XR application or device, etc. XR traffic bursts may be periodic but may include some time jitter in their arrival, and the XR packet sizes, and the number of packets, for certain bursts may be variable. That is, XR service characteristics such as periodicity, multiple flows, jitter, latency, reliability, etc., may affect signaling throughput, latency, and other operations at base stations and other devices such as UEs on a wireless communication network. Additionally, XR operations/applications may utilize sensing, e.g., RF sensing, to sense environments in which a UE, terminal, access point, etc., is located.

However, existing configurations/implementations do not provide for enabling sensing in DRX, e.g., for XR, with additional power savings, and when XR is enabled with JCS, sensing configurations may not enhance XR performance. Further, in XR, traffic patterns may be impacted by latency constraints and the actions of users, e.g., pose, gestures, etc. Therefore, DRX patterns may not conform to static expectations, e.g., one uniform distribution of the onDuration in time. Accordingly, configuring sensing resources in this context may be problematic.

Various aspects relate generally to wireless communications systems and sensing operations for wireless devices. Some aspects more specifically relate to joint resource allocation for UE power savings in JCS. In one example, a UE may receive a sensing pattern configuration and/or an indication thereof from a network node. The sensing pattern configuration may be associated with a sensing resource and may include an offset window. The sensing pattern configuration may be further associated with (1) a first association of a first discontinuous reception (DRX) pattern of the network node with a second DRX pattern of the UE, or (2) a second association of the first DRX pattern of the network node with data communications. The UE may activate the sensing resource at an activation time for a sensing occasion after a start of the offset window. The offset window may correspond to (1) a first end of an active duration at the UE prior to a first start of a next sensing occasion, (2) a second start of the active duration at the UE after a prior sensing occasion, and/or (3) a data communication. In another example, a network node, e.g., a base station and/or the like, may configure a sensing pattern configuration for a UE. The sensing pattern configuration may be associated with a sensing resource for a sensing occasion and may include an offset window. The sensing pattern configuration may be further associated with (1) a first association of a first discontinuous reception (DRX) pattern of the network node with a second DRX pattern of the UE, or (2) a second association of the first DRX pattern of the network node with data communications. The offset window may correspond to (1) an end of an active duration for the UE prior to a first start of a next sensing occasion, (2) a second start of the active duration for the UE after a prior sensing occasion, and/or (3) a data communication. The network node may transmit the sensing pattern configuration and/or an indication thereof for the UE.

Particular aspects of the subject matter described in this disclosure can be implemented to realize one or more of the following potential advantages. In some examples, by activating sensing occasions that align with DRX pattern on/active durations for joint resource configurations, the described techniques can be used to reduce power consumption at the sensing device (e.g., a UE, etc.) while still improving communications via sensing (e.g., for XR). In some examples, by activating sensing occasions that align with DRX pattern on/active durations for JCS based on alignment rules, the described techniques can be used to indicate individual sensing occasions, configure pre-defined sensing patterns, further enhance communications with sensing, and maintain phase coherency for sensing occasions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

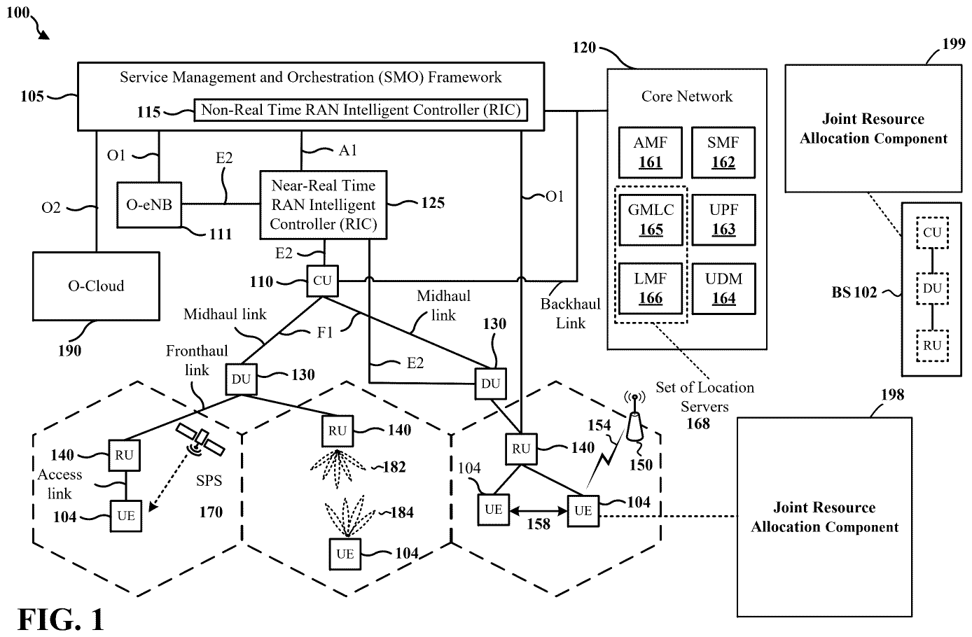

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (0-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a joint resource allocation component 198 (“component 198”) that may be configured to receive, from a network node, an indication of a sensing pattern configuration, where the sensing pattern configuration is associated with a sensing resource and includes an offset window, where the sensing pattern configuration is further associated with (1) a first association of a first discontinuous reception (DRX) pattern of the network node with a second DRX pattern of the UE, or (2) a second association of the first DRX pattern of the network node with data communications. The component 198 may also be configured to activate the sensing resource at an activation time for a sensing occasion after a start of the offset window, where the offset window corresponds to at least one of (1) a first end of an active duration at the UE prior to a first start of a next sensing occasion, (2) a second start of the active duration at the UE after a prior sensing occasion, or (3) a data communication. The component 198 may be configured to provide, for the network node, a capability indication that is associated with the minimum value, where the capability indication indicates at least one of first support for simultaneous processing of communication operations and sensing operations or second support for the offset window based on a switching duration from the communication operations to the sensing operations. The component 198 may be configured to activate an additional sensing resource at an additional activation time for an additional sensing occasion during the additional offset window. The component 198 may be configured to receive an image of the XR session that is included in the data communication. The component 198 may be configured to adjust or render the image included in the data communication based on the sensing occasion. In certain aspects, the base station 102 may have a joint resource allocation component 199 (“component 199”) that may be configured to configure a sensing pattern configuration for a user equipment (UE), where the sensing pattern configuration is associated with a sensing resource for a sensing occasion and includes an offset window, where the sensing pattern configuration is further associated with (1) a first association of a first discontinuous reception (DRX) pattern of the network node with a second DRX pattern of the UE, or (2) a second association of the first DRX pattern of the network node with data communications, and where the offset window corresponds to at least one of (1) an end of an active duration for the UE prior to a first start of a next sensing occasion, (2) a second start of the active duration for the UE after a prior sensing occasion, or (3) a data communication. The component 199 may also be configured to transmit, for the UE, an indication of the sensing pattern configuration. The component 199 may be configured to receive, from the UE, a capability indication that is associated with the minimum value, where the capability indication indicates at least one of first support for the simultaneous processing of the communication operations and the sensing operations or second support for the offset window based on a switching duration from the communication operations to the sensing operations. That is, aspects provide for joint resource allocation for UE power savings in JCS that enables configurations for sensing patterns and associations to data thereof by which power savings at the sensing device are realized while still providing for enhancements to data communications through sensing. That is, aspects herein provide for reductions in power consumption at sensing devices (e.g., a UE, etc.) while still improving communications via sensing (e.g., for XR) by activating sensing occasions that align with DRX pattern on/active durations for joint resource configurations, and aspects also provide for indications of individual sensing occasions, configurations for pre-defined sensing patterns, further enhancements communications with sensing, and maintenance of phase coherency for sensing occasions by activating sensing occasions that align with DRX pattern on/active durations for JCS based on alignment rules.

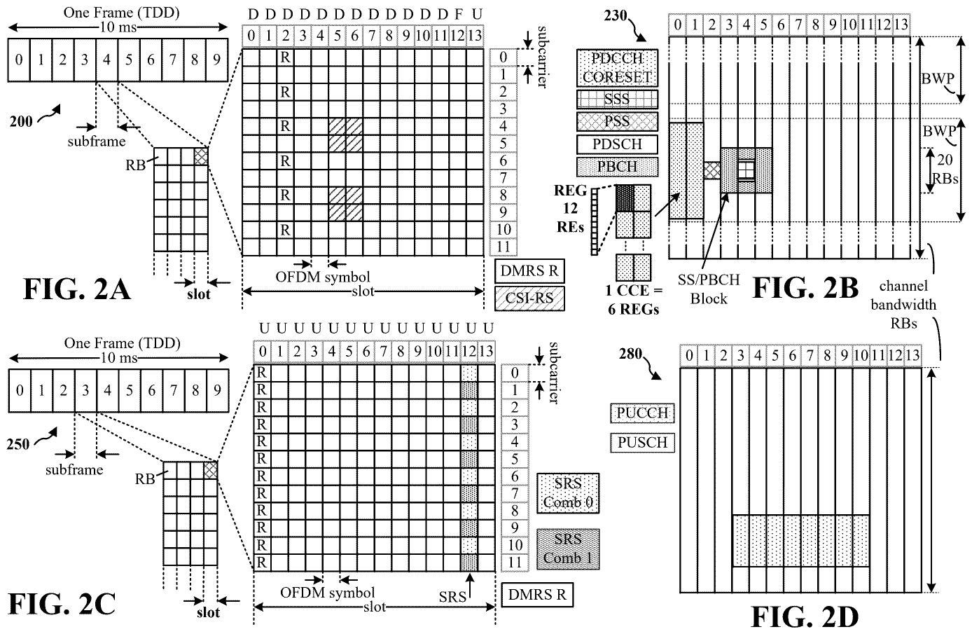

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

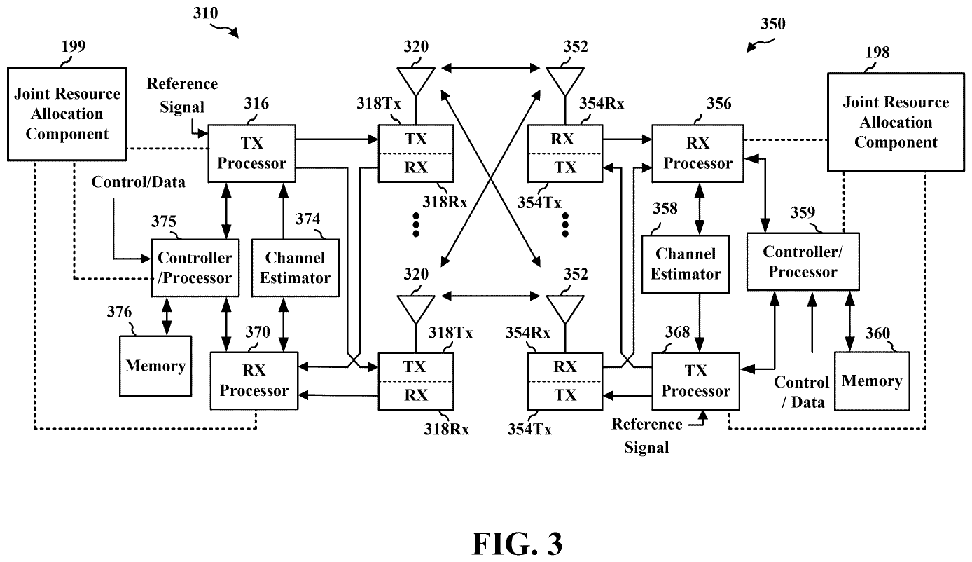

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

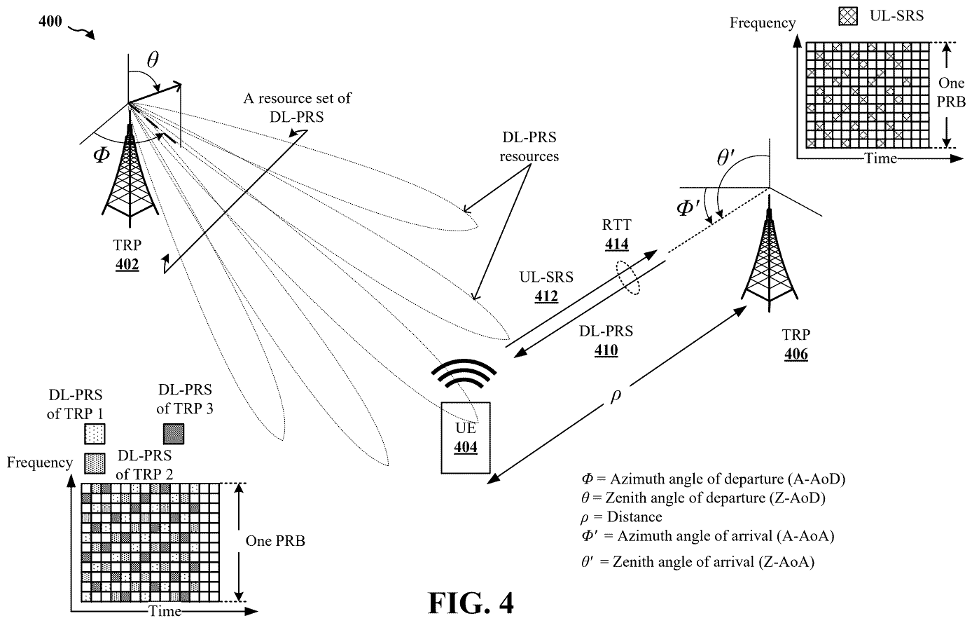

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s)168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In addition to network-based UE positioning technologies, a wireless device (e.g., a UE, an AP, etc.) may also be configured to include sensing capabilities, where the wireless device may be able to sense (e.g., detect and/or track) one or more objects or target entities of an area or in an environment, including users and other people, based on radio frequencies/RADAR. An environment may refer to a particular geographical area or place, especially as affected by human activity, or the circumstances, objects, or conditions by which one is surrounded. For example, a wireless device may include a RADAR capability (which may be referred to as “RF sensing” and/or “cellular-based RF sensing), where the wireless device may transmit reference signals (e.g., RADAR reference signals (RRSs)) and measure the reference signals reflected from one or more objects (e.g., structures, walls, living objects, poses/gestures of users, and/or other things in an environment, etc.). Based on the measurement, the wireless device may determine or estimate a distance between the wireless device and the one or more objects and/or obtain environmental information associated with its surrounding including, but without limitation, range, Doppler, and/or angle information of sensing target entities. In another example, a first wireless device may receive signals transmitted from a second wireless device, where the first wireless device may determine or estimate a distance between the first wireless device and the second wireless device based on the received signals. For example, a tracking device (e.g., a Bluetooth™ tracker, an item tracker, an asset tracking device, etc.) may be configured to regularly transmit signals (e.g., beacon signals) or small amounts of data to a receiving device, such that the receiving device may be able to monitor the location or the relative distance of the tracking device. As such, a user may be able to track the location of an item (e.g., a car key, a wallet, a remote control, etc.) by attaching the tracking device to the item. For purposes of the present disclosure, a device/apparatus that is capable of performing sensing (e.g., transmitting and/or receiving signals for detecting at least one object or for estimating the distance between the device and the at least one object) may be referred to as a “sensing device,” a “sensing node,” or a “sensing entity.” For example, a sensing device may be a UE, an AP device (e.g., a Wi-Fi router), a base station, a component of the base station, a TRP, a device capable of performing radar functions, etc. Furthermore, a target entity may be any object (e.g., a person, a vehicle, a UE, etc.) for which a positioning or sensing session is performed, for example, to determine a location thereof, a velocity thereof, a heading thereof, a physiological characteristic thereof, etc. In addition, a device/apparatus that is capable of transmitting signals to a sensing device for the sensing device to determine the location or the relative distance of the device/apparatus may be referred to as a “tracking device,” a “tracker,” or a “tag.”

For purposes of the present disclosure, a positioning session may be referred to the transmitting, the receiving, and the measuring of reference signals for the purposes of determining a positioning result or state (e.g., a location, a heading, a velocity, etc.) of a target entity. A sensing session may be referred to the transmitting, the receiving, and the measuring of reference signals for the purposes of determining a sensing result or state of an environment in which the target entity is included (e.g., a change in the environment), at least one physiological characteristic of a target entity, a location of the target entity, a velocity of the target entity, a heading of the target entity, etc. A sensing session may be performed over one or more sensing occasions, where an individual sensing occasion may be a length of time in which sensing resources (e.g., FMCW bandwidth, OFDM bandwidth, etc.) may be available for sensing operations.

Traffic flows may have various characteristics in wireless communication networks, e.g., including layer attributes, timeframes for latency, etc. As an example, extended reality (XR) traffic for UL and DL may have characteristics such as application layer attributes, short timeframes for exchange where longer latency for traffic flows may reduce a user experience with an XR application or device, etc. XR traffic bursts may be periodic but may include some time jitter in their arrival, and the XR packet sizes, and the number of packets, for certain bursts may be variable. That is, XR service characteristics such as periodicity, multiple flows, jitter, latency, reliability, etc., may affect signaling throughput, latency, and other operations at base stations and other devices such as UEs on a wireless communication network. Additionally, XR operations/applications may utilize sensing, e.g., RF sensing, to sense environments in which a UE, terminal, access point, etc., is located. However, existing configurations/implementations do not provide for enabling sensing in DRX, e.g., for XR, with additional power savings, and when XR is enabled with JCS, sensing configurations may not enhance XR performance. Further, in XR, traffic patterns may be impacted by latency constraints and the actions of users, e.g., pose, gestures, etc., and thus, DRX patterns may not conform to static expectations, e.g., one uniform distribution of the onDuration in time, which may make configuring sensing resources in this context problematic.

As noted, aspects herein may relate to joint resource allocation for UE power savings in JCS. In one example, a UE may receive a sensing pattern configuration (e.g., a configuration that indicates periodicity, length, activation, resources, and/or other parameters for sensing operations) and/or an indication thereof from a network node. The sensing pattern configuration may be associated with a sensing resource and may include an offset window. The sensing pattern configuration may be further associated with (1) a first association of a first discontinuous reception (DRX) pattern (e.g., periodic cycles of signaling, timers, etc.) of the network node with a second DRX pattern of the UE, or (2) a second association of the first DRX pattern of the network node with data communications. The UE may activate the sensing resource at an activation time for a sensing occasion after a start of the offset window. The offset window may correspond to (1) a first end of an active duration at the UE prior to a first start of a next sensing occasion, (2) a second start of the active duration at the UE after a prior sensing occasion, and/or (3) a data communication. In another example, a network node, e.g., a base station and/or the like, may configure a sensing pattern configuration for a UE. The sensing pattern configuration may be associated with a sensing resource for a sensing occasion and may include an offset window. The sensing pattern configuration may be further associated with (1) a first association of a first discontinuous reception (DRX) pattern of the network node with a second DRX pattern of the UE, or (2) a second association of the first DRX pattern of the network node with data communications. The offset window may correspond to (1) an end of an active duration for the UE prior to a first start of a next sensing occasion, (2) a second start of the active duration for the UE after a prior sensing occasion, and/or (3) a data communication. The network node may transmit the sensing pattern configuration and/or an indication thereof for the UE.

Various aspects herein may provide reductions in power consumption at the sensing device (e.g., a UE, etc.) while still improving communications via sensing (e.g., for XR) by activating sensing occasions that align with DRX pattern on/active durations for joint resource configurations. That is, aspects enable the sensing occasions to be aligned with the DRX pattern of data communications, and may not activate additional wake up events when alignment is not present. Moreover, configurable offset windows described herein enable a network node/base station to configure larger or smaller gaps between active durations and sensing occasions as determinate for sensing activations, where smaller gaps may provide additional power savings at the sensing device. Various aspects may also indicate individual sensing occasions, configure pre-defined sensing patterns, further enhance communications with sensing, and maintain phase coherency for sensing occasions by activating sensing occasions that align with DRX pattern on/active durations for JCS based on alignment rules.

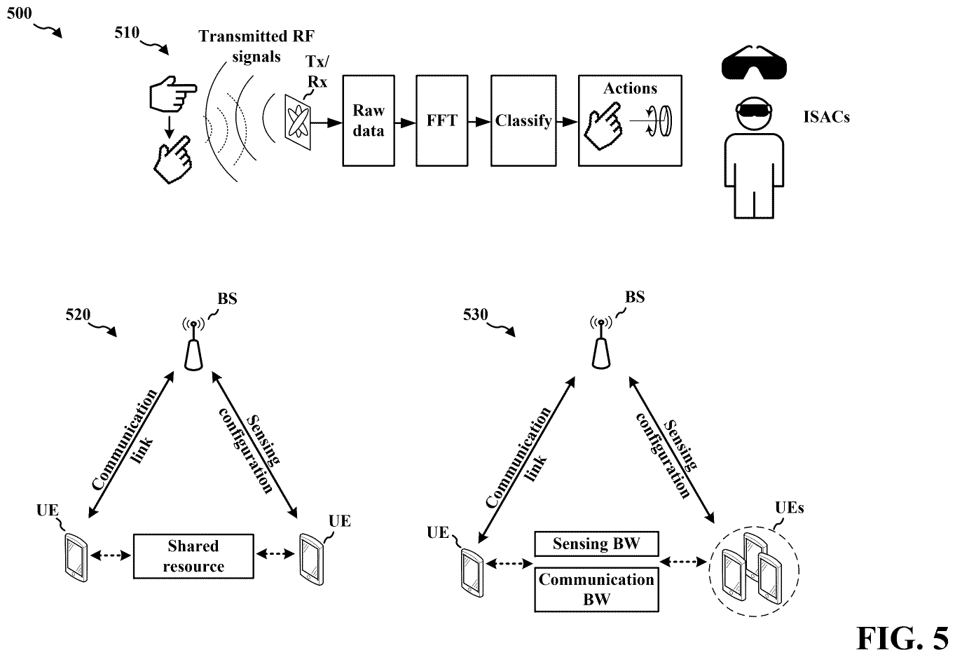

FIG. 5 is a diagram 500 illustrating examples of RF sensing configurations and XR, in various aspects. Diagram 500 shows a configuration 510 for RF sensing in XR, a configuration 520 for sensing configuration with a shared resource, and a configuration 530 for sensing configuration with separate sensing and communication bandwidth (BW).

RF sensing may include radio assisted detection and ranging (RADAR) signals that image an environment, e.g., based on the estimated range, Doppler, and/or angle information, etc. In some configurations, a higher frequency/larger bandwidth, and/or a more compact array, may provide better granularity in sensing, which may be applicable for a mobile device/UE or an AP for sensing. Handheld RADAR devices may be utilized in applications such as gesture classification and interaction (e.g., hand motions), XR control, etc. The overall of the application may be represented in the configuration 510. For example, Tx/Rx sensing chips may send RADAR signals with pre-defined waveforms, e.g., frequency modulated continuous wave (FMCW) signals, OFDM signals, and/or others. Reflected signals (Rx) are correlated with Tx signals to obtain the range, Doppler, and/or angle information. Raw data may be processed, e.g., via fast Fourier transform (FFT), etc., to make the gesture classification and map the gesture to the designed actions, e.g., for XR. Integrated Sensing and Communication (ISAC) may refer to enabling the combination of the sensing and communication systems to utilize resources efficiently and/or pursue mutual benefits thereof. ISAC may utilize sensing functions in legacy communication structures, where sensing resources may be configured by the network and may coexist with data transmissions.

Regarding the configuration 520 and the configuration 530, a network (e.g., a base station and/or the like) may schedule sensing resources within a licensed band. As shown in the configuration 520, the communication and sensing may be configured with separate waveforms in the same/shared resource or BW. For the configuration 520, in the shared resource, communication may be performed with OFDM waveforms, while sensing may be performed with FMCW (or “chirp”) waveforms. In another configuration, not shown, in the same/shared resource, the communication and sensing may be based on the same waveform, as an additional aspect of configuration 520. In such a configuration, the network may configure a single waveform, e.g., OTFS or OFDM, which is used for both data transmission and sensing simultaneously. As shown in the configuration 530, there may be a dedicated resource/BW for sensing, and multiple sensing UEs may share the same sensing resource. In the configuration 530, e.g., with FDD formats, there may one dedicated resource/BW for the sensing application.

Such sensing in JCS may generally be with low priority, compared to legacy communications. For instance, JCS configurations may utilize the additional sensing functions without or limited impact for legacy communications procedure. Integrated sensing may be used to assist the communication, and/or the sensing may monitor the actions around communication nodes. For example, many factors may impact the communications, and such factors can be detected by the sensing. As examples, sensing-assisted beam management (BM) may be implemented, sensing may also be utilized to assist XR control, the sensing results may enable or disable communications for power savings, etc.

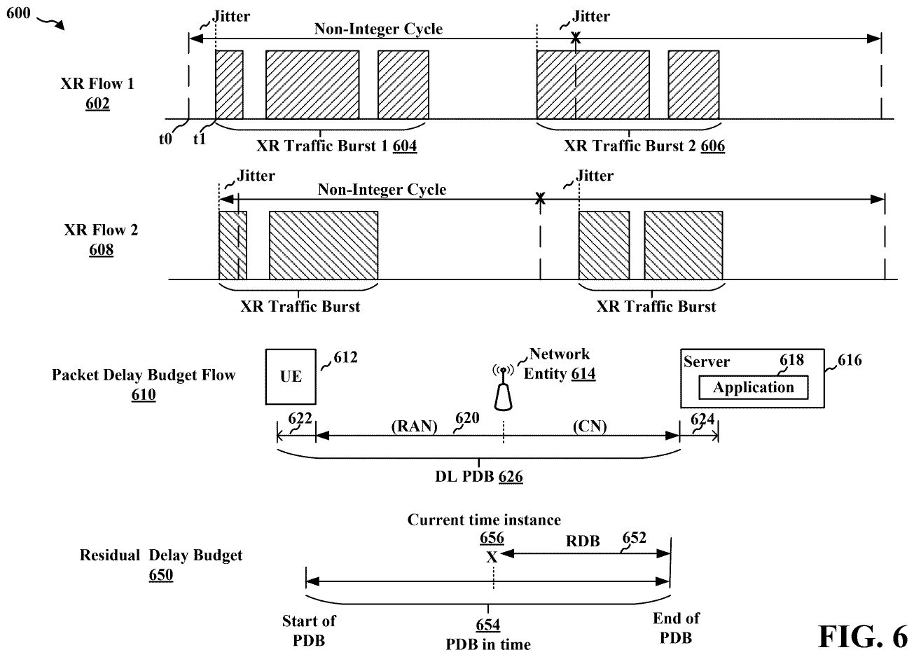

FIG. 6 is a diagram 600 illustrating example XR traffic, in various aspects. XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

XR traffic may arrive in periodic traffic bursts (“XR traffic bursts”). An XR traffic burst may vary in a number of packets per burst and/or a size of each pack in the burst. The diagram 600 illustrates a first XR flow 602 that includes a first XR traffic burst 604 and a second XR traffic burst 606. As illustrated in the diagram 600, the traffic bursts may include different numbers of packets, e.g., the first XR traffic burst 604 being shown with three packets (represented as rectangles in the diagram 600) and the second XR traffic burst 606 being shown with two packets. Furthermore, as illustrated in the diagram 600, the three packets in the first XR traffic burst 604 and the two packets in the second XR traffic burst 606 may vary in size, that is, packets within the first XR traffic burst 604 and the second XR traffic burst 606 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 602, a UE may expect a first packet of the first XR traffic burst 604 to arrive at time t0, but the first packet of the first XR traffic burst 604 arrives at a time t1, as shown.

XR traffic may include multiple flows that arrive at a UE (or a base station) concurrently with one another (or within a threshold period of time). For instance, the diagram 600 includes a second XR flow 608. The second XR flow 608 may have different characteristics than the first XR flow 602. For instance, the second XR flow 608 may have XR traffic bursts with different numbers of packets, different sizes of packets, etc. In an example, the first XR flow 602 may include video data and the second XR flow 608 may include audio data for the video data. In another example, the first XR flow 602 may include intra-coded picture frames (I-frames) that include complete images and the second XR flow 608 may include predicted picture frames (P-frames) that include changes from a previous image.

As noted herein, XR traffic may have an associated e2e PDB. If a packet does not arrive within the e2e PDB, a UE (or a base station) may discard the packet. In an example, if a packet corresponding to a video frame of a video does not arrive at a UE within an e2e PDB, the UE may discard the packet, as the video has advanced beyond the frame. However, the RDB at the UE may be unaccounted for in consideration of discarding packets. An example time diagram 650 shows a length of time corresponding to a PDB 654. At a particular point in time 656, the residual delay budget 652 is the remaining portion of the PDB 654.

An XR traffic overall PDB may include a portion to allow for communication delay of data (e2e PDB) between a UE and a computing device, e.g., a server, hosting an application, e.g., for XR, and a portion for additional time after the communication delay before the data is discarded, e.g., residual delay (e.g., RDB). For instance, the diagram 600 includes a packet delay budget flow 610. Packet delay budget flow 610 illustrates a UE 612, a network entity 614 (e.g., a base station or portion thereof), and a server 616 that hosts an application 618. In the illustrated aspect, a communication delay 620 is shown as including a RAN portion between the UE 612 and the network entity 614, as well as a CN portion between the network entity 614 and the server 616. The communication delay 620 may apply to both UL and DL communications. Additionally, a residual delay 622 is shown at the UE 612 for DL communications and a residual delay 624 is shown at the server 616 for UL communications. The communication delay 620 and the residual delay 622 may make up an overall PDB for DL XR communications, e.g., DL PDB 626. Likewise, the communication delay 620 and the residual delay 624 may make up an overall PDB for UL XR communications (not shown for illustrative clarity).

In general, XR traffic may be characterized by relatively high data rates and low latency. The latency in XR traffic may affect the user experience. For instance, XR traffic may have applications in eMBB and URLLC services.

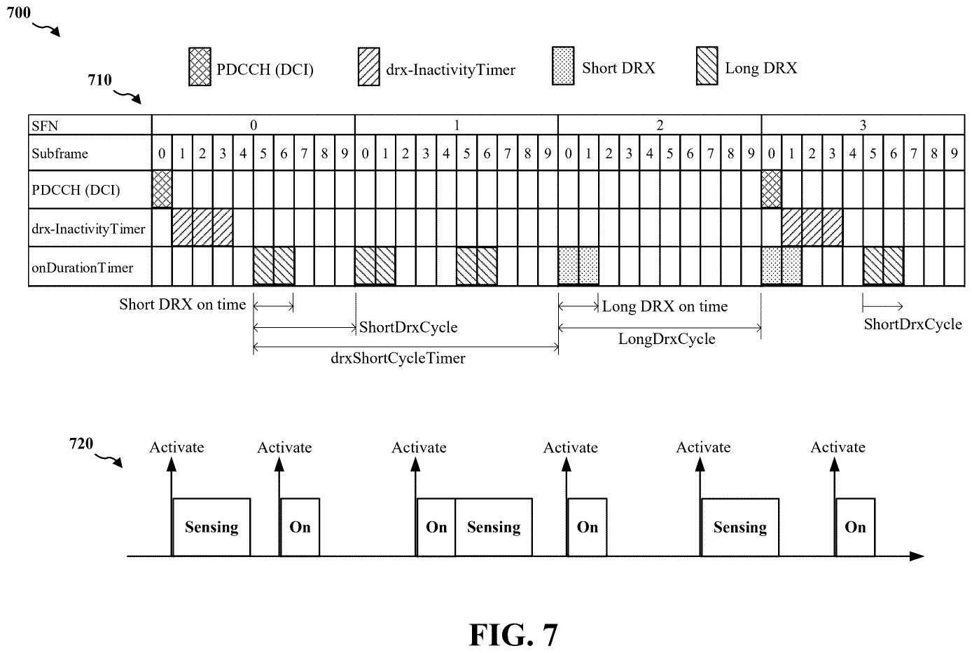

FIG. 7 is a diagram 700 illustrating examples of DRX/XR and JCS, in various aspects. Diagram 700 shows a configuration 710 for DRX/XR, and a configuration 720 for sensing configurations with a shared resource.

Regarding the configuration 710, XR applications and operations may be supported for 5G NR, which may include XR-awareness, XR-specific power savings, and XR-specific capacity improvements. XR specific power saving techniques may accommodate XR service characteristics (e.g., periodicity, multiple flows, jitter, latency, reliability, etc.), and may include connected mode DRX (C-DRX) aspects, PDCCH monitoring aspects, and/or the like. In some aspects, C-DRX may be configured to align with XR traffic periodicity, semi-static solutions may be prioritized, etc. DRX procedures may be configured for UE power savings. For instance, DRX may be utilized as an energy saving technique for 5G terminals. DRX may include two states: an active state (or OnDuration), and sleep/inactive state (Off Sleep). In the active state, a terminal may monitor a DL channel, such as PDCCH, and receive corresponding data. In the sleep state, a terminal may close the receiving unit and no longer monitor the DL channel, such as PDCCH, so as to achieve the purpose of energy savings. In XR, if the DRX periodicity matches the traffic arrival of the data flow, then a dynamic grant (DG) may be used to support XR traffic, which may save the UE additional power. In other words, DRX may be an energy saving technique for 5G terminals (e.g., for XR devices) with two states: an active state (OnDuration) and a sleep state (Off Sleep). Enabling JCS in XR applications utilizes additional wake ups and power consumption. Aligning sensing occasions with the DRX pattern of data communication may eliminate additional wake up events, but may impact latency. In one aspect, the network may configure a sensing pattern associated with a DRX pattern. A configured offset window may allow the UE to follow DRX and switch to the sleep mode. Furthermore, the UE may perform sensing before data communications when awake. The configuration 710 shows example parameters for DRX, including but without limitation, short and long DRX configurations, an inactivity timer, and an onDuration timer.

Regarding the configuration 720, power savings at the UE may be desired in the context XR implementations. DRX may save the UE power, such as when the XR traffic pattern can match the predefined DRX pattern, e.g., aligned with the DRX configuration, where the UE will wake up to monitor the traffic in the onDuration occasion, leaving the UE in the sleep state most of the time. Additionally, in JCS, sensing may assist with communications, e.g., the BM, and further, in XR, sensing may be an integral component for applications/operations, which may assist the interactions and communications for less latency or for performance enhancements. Yet, when enabling JCS in XR, such sensing may involve additional power consumption. For example, within the legacy DRX configuration in XR, one additional sensing pattern may be configured, and the UE may frequently wake up for communications, or for sensing. Such sensing patterns may reduce the power saving gain of DRX in XR. As shown in the configuration 720, such configured sensing may lead to an additional two wake up evens, as well as more power consumption compared to non-sensing configurations.

Simply put, existing configurations/implementations do not provide for enabling sensing in DRX, e.g., for XR, with additional power savings, and when XR is enabled with JCS, sensing configurations may not enhance XR performance.

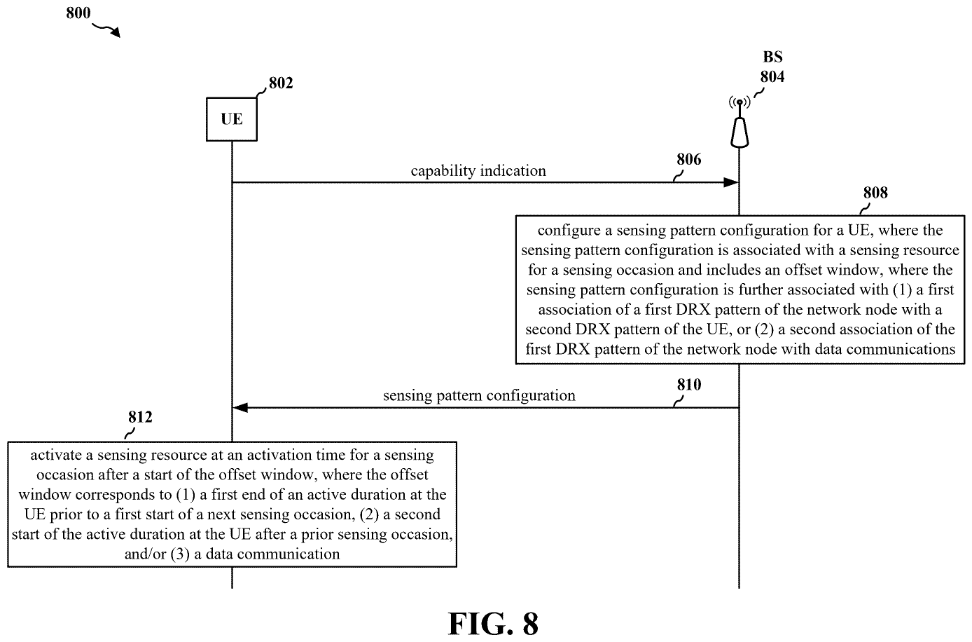

FIG. 8 is a call flow diagram 800 for wireless communications, in various aspects. Call flow diagram 800 illustrates configurations for joint resource allocation for UE power savings in JCS by a UE (e.g., a UE 802) that may communicate with a network node (a base station 804, such as a gNB or other type of base station, by way of example, as shown). Aspects described for the base station 804 may be performed by the base station in aggregated form and/or by one or more components of the base station 804 in disaggregated form. Additionally, or alternatively, the aspects may be performed by the UE 802 autonomously, in addition to, and/or in lieu of, operations of the base station 804.

In the illustrated aspect, the UE 802 may provide, to the base station 804, a capability indication 806. The capability indication 806 may be associated with a minimum value for an offset window utilized to determine activations of sensing resources. The capability indication 806 may indicate first support for simultaneous processing of communications operations and sensing operations and/or second support for the offset window based on a switching duration from the communications operations to the sensing operations.

The base station 804 may configure (at 808) a sensing pattern configuration 810 for the UE 802. The sensing pattern configuration 810 may be associated with a sensing resource, e.g., of the UE 802, for a sensing occasion and may include an indicate the offset window, or another offset window, based on the capability indication 806. In aspects, the sensing pattern configuration 810 may be associated with (1) a first association of a first DRX pattern of the base station 804 with a second DRX pattern of the UE 802, or (2) a second association of the first DRX pattern of the base station 804 with data communications.

In aspects, the offset window may be based on a minimum value and a maximum value that are indicated in the sensing pattern configuration 810. In such a configuration, the minimum value may be based on a switching capability of the UE 802 and may be associated with an offset between the offset window and an active duration, e.g., for the DRX pattern at the UE 802. In such configurations, the maximum value may be based on a maximum time between consecutive sensing occasions the UE 802 (e.g., the time a UE waits until a next sensing occasion). In some aspects, the minimum value may be set to zero or approximately zero in the sensing pattern configuration 810 based on the switching capability of the UE 802 indicating a capability, e.g., via capability indication 806, for simultaneous processing of communication operations and sensing operations by the UE 802. In some aspects, the offset window may be based on a minimum value indicated the sensing pattern configuration 810 and/or a data communication associated with an active duration, e.g., of the DRX pattern. In such configurations, the minimum value may be based on a switching capability of the UE and may be associated with an offset between the offset window and the data communication.

The base station 804 may be configured to provide/transmit, and the UE 802 may be configured to receive, the sensing pattern configuration 810 and/or an indication thereof. The UE 802 may be configured to activate the sensing resource at an activation time for a sensing occasion after a beginning of the offset window, e.g., based on the sensing pattern configuration 810. In aspects, the offset window may correspond to (1) a first end of an active duration at the UE 802 prior to a first start of a next sensing occasion, (2) a second start of the active duration at the UE 802 after a prior sensing occasion, and/or (3) a data communication.

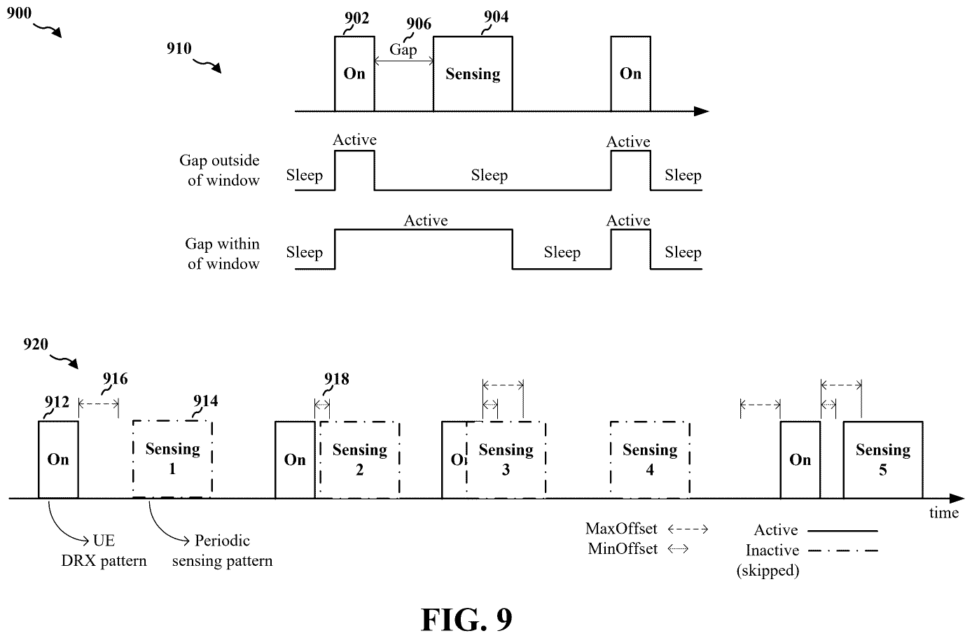

FIG. 9 is a diagram 900 illustrating examples of DRX patterns and sensing configurations, in various aspects. Diagram 900 shows a configuration 910 for DRX and sensing patterns with respect to active and sleep times, and a configuration 920 DRX and sensing patterns via an offset window for activation.

In the configuration 910, an active duration 902 (also “onDuration,” herein) and a sensing occasion 904 are shown. As illustrated, between a first active duration 902 and the sensing occasion 904 is a gap 906. In aspects, when the gap 906 is within an offset window, as described in further detail herein, the sensing occasion 904 may be activated (e.g., by a UE). In aspects, such as for JCS, a pre-defined sensing pattern may be configured for the sensing, e.g., one static periodical pattern. The sensing pattern may be adapted into a DRX pattern, e.g., for XR power savings. In one such aspect, a network node/base station may configure a sensing pattern, and the sensing pattern may be configured in association with a DRX pattern, e.g., based on one or more rules that enable/disable the sensing occasions in the pattern. In such a sensing pattern configuration, there may be 1 bit to indicate such a pattern to associate with the UE DRX pattern.

In aspects, the network node/base station may configure an offset window, which may include, and/or be defined/bounded by. two parameters: a minimum offset value and a maximum offset value (or [MinOffset, MaxOffset]). In aspects, when the gap 906 is between the end of active duration (onDuration) and the starting point of a predefined sensing occasion is within such an offset window, the sensing occasion resource may be enabled/activated. If so, the UE may remain active until the end of the sensing, e.g., from the active duration (onDuration) through the sensing. In such configurations, the minimum offset value may be determined by a capability of the UE for switching from communications to sensing. In configurations for which the UE has the capability to simultaneously process the communication and sensing, the minimum offset value may be zero (or [MinOffset=0]). Aspects, herein provide for a UE to report its capability in this regard. As one example, the UE may report whether the UE supports the simultaneous processing for the communication and sensing. In another example, the UE may report the minimum/least amount of time (or offset) for the switching from communication and sensing operations. The maximum offset value may be determinative of the maximum/largest time which the UE may wait for the following/next sensing occasion. If the maximum offset value is set to be too large, which means that the UE would keep active for a long time to wait for the next sensing occasion, there is more of a power cost for the UE to perform the sensing. According to aspects, if the gap 906 is larger than the configured maximum offset value, the following sensing occasion may be skipped, and UE may remain in the sleep state.

As shown in the configuration 910, the active duration 902 may represent that the UE is not in the sleep state, but rather is active for performing communications or sensing. If the gap 906 is outside of the configured offset window, the UE may follow legacy DRX protocols and switch to the sleep state. However, if the gap 906 is within the configured offset window, the UE may extend the extend the active time past the active duration 902, such that the UE remains active to also perform sensing (e.g., active time=onDuration time+gap+sensing occasion=the first active duration 902+the gap 906+the sensing occasion 904).

In the configuration 920, active durations 912 and sensing occasions 914 are shown. The active durations 912 may be associated with a UE DRX pattern, and the sensing occasions 914 may be associated with a periodic sensing pattern at the UE. Also illustrated for the configuration 920 are representations of a maximum offset 916 and a minimum offset 918, as similarly described above for the configuration 910. DRX patterns may generally not be uniform and/or static, e.g., may be impacted by short/long DRX cycles and/or arriving data traffic. Therefore, one pre-defined sensing pattern may not always align with the DRX pattern at the UE. Aspects herein provide for the use of offset windows, e.g., as rules for activation of the sensing occasions 914 in the sensing pattern, for associations between the active durations 912 (e.g., onDurations) in the DRX pattern and the sensing occasions 914 in the sensing pattern at the UE. That is, if a given one of the sensing occasions 914 starts within the offset window (e.g., after the minimum offset 918 and before the maximum offset 916, that sensing occasion may be activated.

As one example, a first of the sensing occasions 914 begins after the maximum offset 916 with respect to the first of the active durations 912, e.g., there is too large of a gap between the first of the sensing occasions 914 and the first of the sensing occasions 914. When such a gap is larger than the value of the maximum offset 916, the sensing occasion may be skipped, and the UE may switch to the sleep state after the onDuration (e.g., the first of the active durations 912).

As another example, a second of the sensing occasions 914 begins before the minimum offset 918 with respect to the second of the active durations 912, e.g., there is too small of a gap (which is smaller than the value of the minimum offset 918), and the second of the sensing occasions 914 does not fall within the offset window. Therefore, there may not be enough time for the UE to switch from communication to sensing, and the second of the sensing occasions 914 may also be skipped. As yet another example, a third of the sensing occasions 914, similar to the second of the sensing occasions 914, begins prior to the end of its adjacent one of the active durations 912, which is less of a gap than the minimum offset 918, and thus, the start of the third of the sensing occasions 914 also does not fall within the offset window. It should be noted however, that if the UE has the capability to simultaneously enable sensing and communication operations, the such the minimum offset 918 may be set to 0 (zero), and the second and the third of the sensing occasions 914 may be enabled/activated.

In still another example, the fourth of the sensing occasions 914 may be skipped for at least similar reasons as the first of the sensing occasions 914, e.g., there is not one of the active durations 912 within the maximum offset 916. If the UE remains active until the fourth of the sensing occasions 914, or restarts to be active in such a sensing occasion, there would be additional power consumption at the UE to perform this operation. Finally, the fifth of the sensing occasions 914 is illustrated as matching, or starting within, the predefined offset window constraint and may be enabled for a sensing operation(s). That is, the start of the fifth of the sensing occasions 914 is both after the minimum offset 918 and before the maximum offset 916, and is thus within the offset window per the rules of activation.

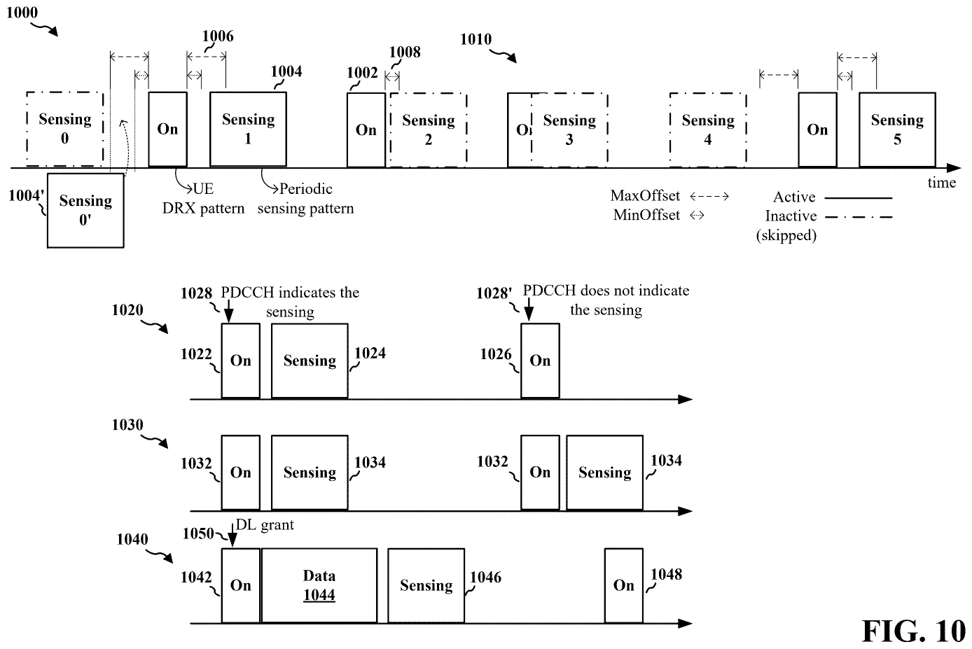

FIG. 10 is a diagram 1000 illustrating examples of DRX patterns and sensing configurations, in various aspects. Diagram 1000 shows a configuration 1010 for DRX and sensing patterns via an offset window for activation, as well as a configuration 1020, a configuration 1030, and a configuration 1040, each for DRX and sensing patterns associated with data communications.

In the configuration 1010, active durations 1002 and sensing occasions 1004 are shown, as similarly described above for the configuration 920 in FIG. 9. The active durations 1002 may be associated with a UE DRX pattern, and the sensing occasions 1004 may be associated with a periodic sensing pattern at the UE. Also illustrated for the configuration 1010 are representations of a maximum offset 1006 and a minimum offset 1008, as similarly described herein. As noted, DRX patterns may generally not be uniform and/or static, e.g., may be impacted by short/long DRX cycles and/or arriving data traffic, and one pre-defined sensing pattern may not always align with the DRX pattern at the UE. Aspects herein provide for the use of offset windows, e.g., as rules for activation of the sensing occasions 1004 in the sensing pattern, for associations between the active durations 1002 (e.g., onDurations) in the DRX pattern and the sensing occasions 1004 in the sensing pattern at the UE. In the configuration 1010, offset windows may be configured before the active durations 1002, or may be configured both before and after the active durations 1002. That is, a UE may be enabled via aspects herein to perform sensing before data communications via configurations made by a network node/base station for the maximum offset 1006 and the minimum offset 1008 to be before and/or after a given one of the active durations 1002 (e.g., the offset window may be defined from an end of a sensing occasion to the start of an active duration).

As one example, a prior one of the sensing occasions 1004 (shown as a “Sensing 0” occasion prior to the first of the active durations 1002), has a gap between itself and the first of the active durations 1002 that is larger than the maximum offset 1006. Thus, the prior one of the sensing occasions 1004 (“Sensing 0”) would be skipped, in aspects, as it is not within a configured offset window. However, another prior one of the sensing occasions 1004′ (“Sensing 0”) is also prior to the first of the active durations 1002, but has a gap between itself and the first of the active durations 1002 that is smaller than the maximum offset 1006 and greater than the minimum offset 1008. In other words, the other prior one of the sensing occasions 1004′ is within the configured offset window, and may be activated prior to the first of the active durations 1002, where the UE may stay active from the start of the other prior one of the sensing occasions 1004′ through the first of the active durations 1002 to perform both sensing and communication operations (subsequent to a switch to a communications mode).

In an additional example, a first of the sensing occasions 1004 begins before the maximum offset 1006 with respect to the first of the active durations 1002 and after the minimum offset 1008, e.g., is within the configured offset window. Accordingly, this sensing occasion may be activated and utilized for sensing prior to the UE switching to the sleep state thereafter.

As another example, a second of the sensing occasions 1004 begins before the minimum offset 1008 with respect to the second of the active durations 1002, e.g., there is too small of a gap (which is smaller than the value of the minimum offset 1008), and the second of the sensing occasions 1004 does not fall within the offset window. Therefore, there may not be enough time for the UE to switch from communication to sensing, and the second of the sensing occasions 1004 may also be skipped. As yet another example, a third of the sensing occasions 1004, similar to the second of the sensing occasions 1004, begins prior to the end of its adjacent one of the active durations 1002, which is less of a gap than the minimum offset 1008, and thus, the start of the third of the sensing occasions 1004 also does not fall within the offset window. It should be noted however, that if the UE has the capability to simultaneously enable sensing and communication operations, the such the minimum offset 1008 may be set to 0 (zero), and the second and the third of the sensing occasions 1004 may be enabled/activated.

In still another example, the fourth of the sensing occasions 1004 may be skipped for at least similar reasons as the first of the sensing occasions 1004, e.g., there is not one of the active durations 1002 within the maximum offset 1006. If the UE remains active until the fourth of the sensing occasions 1004, or restarts to be active in such a sensing occasion, there would be additional power consumption at the UE to perform this operation. Finally, the fifth of the sensing occasions 1004 is illustrated as matching, or starting within, the predefined offset window constraint and may be enabled for a sensing operation(s). That is, the start of the fifth of the sensing occasions 1004 is both after the minimum offset 1008 and before the maximum offset 1006, and is thus within the offset window per the rules of activation.

In other words, aspects provide for offset windows before and/or after active durations (onDurations). An offset window before an active duration may have a prior minimum offset value and a maximum offset value (e.g., [minOffset front, maxOffset]), while an offset window after an active duration may have a subsequent minimum offset value and a maximum offset value (e.g., [minOffset after, maxOffset]).

For instance, a sensing pattern configurations according to aspects herein may include, without limitation, single maximum offset value for both prior and subsequent offset windows. In another aspect, the prior offset value ([minOffset front]) may be determined based on the gap constraint for the UE to switch from sensing to communications. In another aspect, the subsequent offset value ([minOffset after]) may be determined based on the gap constraint for UE to switch from communications to sensing. Thus, the sensing occasions 1004 that meet the constraints for either of the prior or subsequent offset windows may be enabled for the sensing.

The configuration 1020, the configuration 1030, and the configuration 1040 may represent aspects for separate sensing occasions associated with, or patterned in association with, data communications, rather than pre-defined, periodic sensing patterns. For example, a UE may perform sensing operations after data communications are received. That is, after data communications, which may be indicated by a MAC go-to-sleep (e.g., sleep until the next C-DRX active/on duration start) command or a PDCCH skipping go-to-sleep command, the UE may perform sensing, where the sensing location is floating in time, e.g., at an offset after the go-to-sleep starts.

In the configuration 1020, within an active duration 1022, there may be provided 1 (one) bit to grant a sensing occasion 1024 following the data communication associated with the active duration 1022. For instance, a PDCCH 1028 may indicate whether there is a sensing occasion (e.g., the sensing occasion 1024) to associate with a current onDuration (e.g., the active duration 1022). If so, the UE may switch to perform sensing after the onDuration for the data communication. If a PDCCH 1028′ does not indicate that there is a sensing occasion to associate with a current onDuration (e.g., an active duration 1026), the UE may switch to a sleep state after the onDuration for the data communication. In aspects, there may be a default time offset τ to reserve adequate time for the switching from communications to sensing. In some aspects, a network node/base station may specifically configure an offset τ₁, such τ₁≥τ, e.g., a DCI or a MAC CE in the onDuration stage.

In the configuration 1030, there may be sensing occasions associated with each onDuration. As an example, for each instance of an active duration 1032 in the configuration 1030 there may be an associated instance of a sensing occasion 1034. In such aspects, the time offset and the sensing occasion length may be pre-configured, and may be kept as constant.

In the configuration 1040, there may be sensing occasions enabled/activated when there is new DL traffic arriving at the UE in association with the onDurations. For instance, a DL grant 1050 in an active duration 1042 may be an indication of new DL traffic 1044 (e.g., DL data traffic) arriving at the UE, e.g., XR traffic, and subsequent to the new DL traffic 1044, a sensing occasion 1046 may be enabled/activated. In other words, generally, when there is no new DL traffic, e.g., as shown for an active duration 1048, and which may indicate that an XR scenario has not changed, e.g., no pose motions, gestures, etc., sensing may be skipped. Yet, when new DL traffic arrives at the UE, a sensing occasion may be associated with the active duration (onDuration) for which the new DL data traffic is received by the UE.

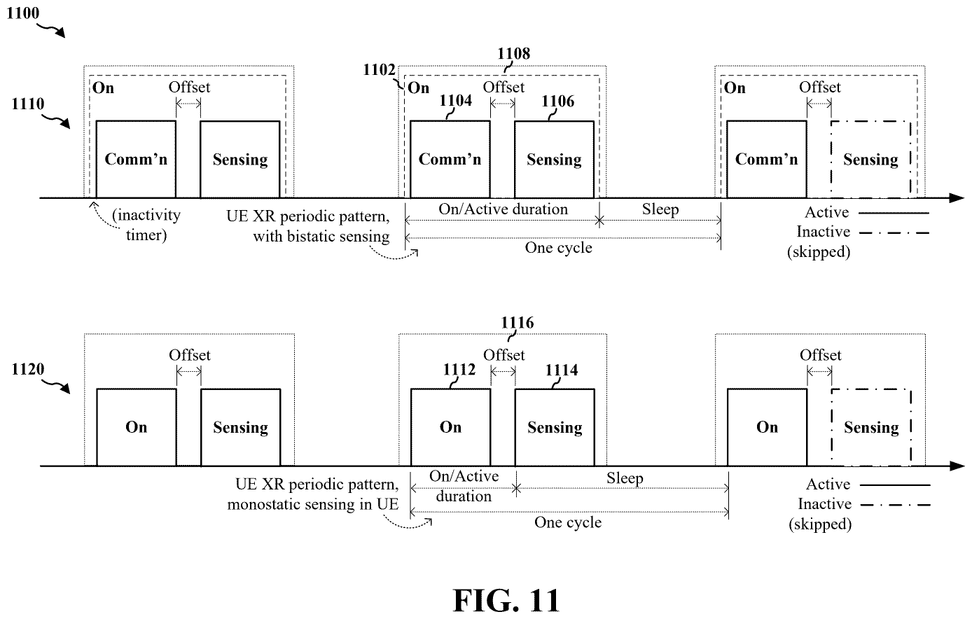

FIG. 11 is a diagram 1100 illustrating examples of DRX/XR patterns with bistatic and monostatic sensing configurations, in various aspects. Diagram 1100 shows a configuration 1110 for DRX/XR and bistatic sensing, as well as a configuration 1120 for DRX/XR and monostatic sensing.

In the configuration 1110, and in the context of bistatic sensing in XR, e.g., from a network node/base station to a UE, both of the sensing and the communications may utilize the connection between the UE and the network. As illustrated in the configuration 1110, a UE may operate according to a periodic XR pattern with an on/active duration and a sleep state per cycle. Accordingly, in aspects, such sensing operations may be defined in the onDuration/active duration stage. For instance, when bistatic sensing is enabled for the UE, within the onDuration/an active duration 1102, the UE may first perform communication operations 1104, and then after an offset 1108, may perform sensing operations 1106. Here, the onDuration/active duration 1102 may include communication and sensing operations. It is also contemplated for the described aspects that a sensing occasion in the UE DRX onDuration/active duration may be skipped based on any rules, configurations, and/or the like herein.

In one aspect, for the DRX configuration, the network node/base station may reuse legacy OnDurationTimer and drx-inactivity timers. Such settings may be utilized when the UE is capable of simultaneously performing sensing and communications operations. Alternatively, the network node/base station may utilize a newly defined OnDurationTimer and/or a newly defined drx-inactivity timer, according to the aspects herein. Such new timers may have larger/longer values with respect to their legacy counterparts in order to include additional time for the sensing operations. In yet another aspect, the network node/base station may utilize/define a constant sensing timer for the sensing operations. For, instance, an actual or realized on-duration timer may be equal to: legacy OnDurationTimer+sensing timer+offset 1108 (or when the offset 1108 is included in the sensing timer, the actual or realized on-duration timer may be equal to: legacy OnDurationTimer+sensing timer). Similarly, an actual or realized drx-inactivity timer may be equal to: legacy drx-inactivity+sensing timer+offset 1108 (or when the offset is included in the sensing timer, the actual or realized drx-inactivity timer may be equal to: legacy drx-inactivity+sensing timer).

In the configuration 1120, and in the context of monostatic sensing in XR, e.g., without a connection to a network node/base station from a UE, sensing may be performed by the UE, and in aspects, the UE may perform sensing based on self-implementation. As illustrated in the configuration 1120, a UE may operate according to a periodic XR pattern with an on/active duration and a sleep state per cycle, where it should be noted that the on/active duration may be shorter than in the configuration 1110, and the sleep state may be longer than in the configuration 1110. Accordingly, in contrast to the configuration 1110, monostatic sensing operations may be defined outside the onDuration/active duration stage for the configuration 1120. For instance, when monostatic sensing is enabled for the UE, within the onDuration/an active duration 1112, the UE may perform communication operations, and then after an offset 1116 and a switch to the sleep state, the UE may perform sensing operations 1114. Here, the onDuration/active duration 1112 may include communication operations but not sensing operations.

In aspects, after the offset 1116, the UE may reuse the communication resource (configured for the onDuration/the active duration 1112, e.g., OFDM signals, FMCW signals, etc.) in the sensing operations. The UE may self-determine whether there is to be sensing after a given active duration 1112 (e.g., each onDuration), or the UE may operate according to configured rules for sensing occasion activations, e.g., as described above and shown for FIG. 10 (such as in the configuration 1020, the configuration 1030, the configuration 1040, and/or the like). For example, a PDCCH may indicate there is to be a sensing occasion activated at the end of an associated UE DRX onDuration/active duration. As another example, a PDCCH may indicate to disable (e.g., skip) a sensing occasion in the associated sleep state, which may reduce the interference for other operations, devices, etc.

Additionally, sensing occasions may be enabled prior to data transmissions/communications for aspects of the configuration 1110 and/or the configuration 1120, as similarly described above with respect to FIG. 10 and the configuration 1010. In aspects, sensing occasions that come before an onDuration/active duration may be specifically associated to that onDuration/active duration as there may not be an express configuration or other indication prior to the sensing occasion.

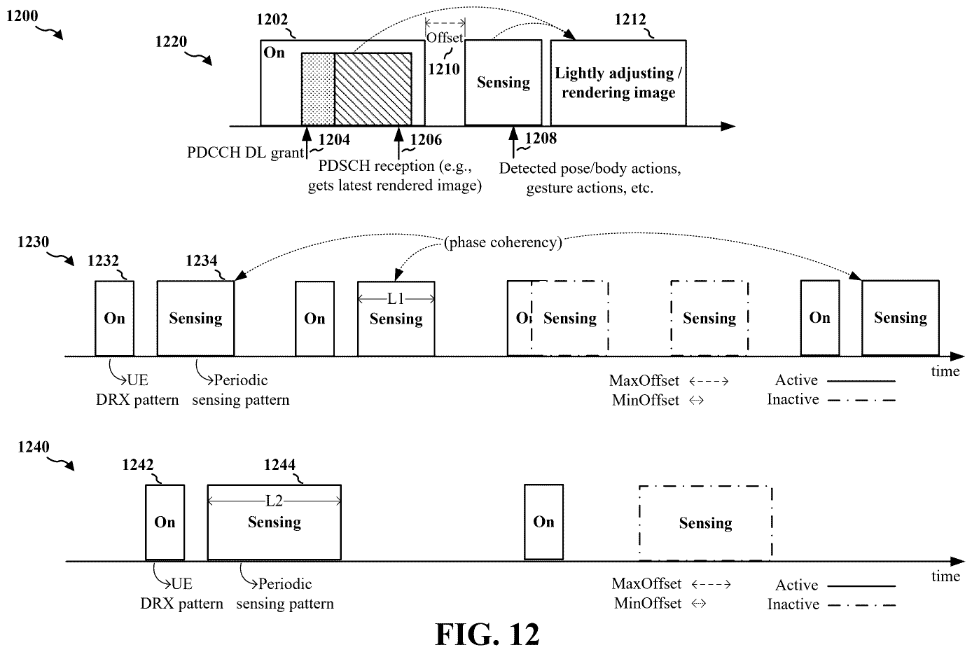

FIG. 12 is a diagram 1200 illustrating examples of DRX/XR patterns and sensing configurations, in various aspects. Diagram 1200 shows a configuration 1220 for XR enhancements via sensing based on DRX/XR patterns, a configuration 1230 for sensing activations with phase coherency, and a configuration 1240 for sensing activations without phase coherency.

In the configuration 1220, sensing is performed to enhance the XR performance, according to aspects. As examples, a sensing device, such as a UE, may sense the pose or gesture(s) of a user before data communication starts, or may sense after data reception for application layer processing of data based on spatial information of the UE. The configuration 1220 illustrate, by way of example and not limitation, performing sensing after a data communication. For example, in an active duration 1202 (onDuration), the UE may receive the latest DL data traffic, e.g., an image, for display by the UE. The DL data traffic may be associated with a PDCCH DL grant 1204 for reception of the data via a PDSCH 1206. In some cases, such an image may be out of date, e.g., as compared to the real-time UE actions. Aspects herein enable the UE to enable/activate a sensing occasion 1208, e.g., after an offset 1210 (as described herein), to obtain up-to-date sensing information associated with the image received in the DL data traffic. In aspects, this process may be similar to that as described above and shown for FIG. 10 (such as in the configuration 1020, the configuration 1030, the configuration 1040, and/or the like). That is, when there is new DL data traffic received, a following sensing occasion (e.g., the sensing occasion 1208) may be enabled.

After the image reception in the PDSCH 1206, a sensing operation via the sensing occasion 1208 may further detect/track new or more recent user actions. Accordingly, aspects herein enhance XR applications and processes by lightly and locally adjusting/rendering 1212 the image to better match the real-time scenarios for XR. That is, by way of example, a UE may wake up from a sleep state and switch to an active state in the active duration 1202 to obtain the PDCCH DL grant 1204 to receive the DL data traffic in the PDSCH 1206. After the end of the active duration 1202, the UE may switch back to the sleep state in the communication. After the offset 1210, the UE may perform monostatic sensing in the sensing occasion 1208 to detect the actions, e.g., body motions, gestures, etc., of users. Based on the new actions detected via the sensing, the UE may be configured to adjust/render 1212 the image to match the real-time scenarios, and then display the new image at the UE for a user(s).

The configuration 1230 and the configuration 1240 illustrate aspects associated with phase coherency considerations. Phase coherency may be considered in aspects herein to achieve higher accuracy in sensing, e.g., for Doppler estimations. When a sensing occasion is associated to an active duration/onDuration in DRX, it may be determined that phase coherency may be recovered, or not, with respect to a threshold condition. Aspects herein provide for configuring lengths of sensing occasions based on the capability of the UE to recover the phase coherency.

In the configuration 1230 for sensing activations with phase coherency, if a UE is able to recover the phase coherency with respect to a recovery threshold (e.g., based on time, quality, generally, and/or the like), the time domain duration (L1) of the sensing occasion instance may be relatively small in order to save UE power. In this case, the UE may be configured to jointly process multiple sensing occasion instances to estimate Doppler measurements across different sensing occasions 1234 subsequent to active durations 1232 in the UE DRX pattern.

In the configuration 1240 for sensing activations without phase coherency, if the UE is unable to recover the phase coherency after sleep with respect to the recovery threshold, a duration of single sensing occasion instance 1244 (subsequent to active durations 1242 in the UE DRX pattern) may be utilized to support the Doppler measurement estimations within some speed range. For this case, each single instance duration (L2) may be relatively large (e.g., larger than L1 described above, larger than an initially configured length, and/or the like). Aspects herein also provide for defining/configuring longer sensing DRX cycles for sensing occasion instances in order to improve the trade-off between XR performance and power savings. In such aspects, a sensing occasion may not always be enabled to improve power savings. For example, as described above and shown for FIG. 10, the configuration 1240 may include considerations such as in the configuration 1020 and the configuration 1040 power savings trade-offs, while the considerations in the configuration 1030 may not be utilized.

Further, aspects herein contemplate additional considerations for XR and JCS. For instance, periodic sensing data may be configured before an active duration/onDuration start, in aspects. For XR traffic, this may include that the periodicity has a non-integer value (e.g., 16.66 ms, 33.33 ms following a XR frame generation rate). Moreover, when considering the reuse of a same waveform in JCS for communications and sensing, a legacy the communication resource configuration may be reused, and a network node/base station may indicate the sensing in such a resource (e.g., without indicating sensing in another resource). For example, in an active duration/onDuration, there may be a MAC-CE/DCI that indicates such a resource is used for sensing and communications, or for communications and not for sensing.

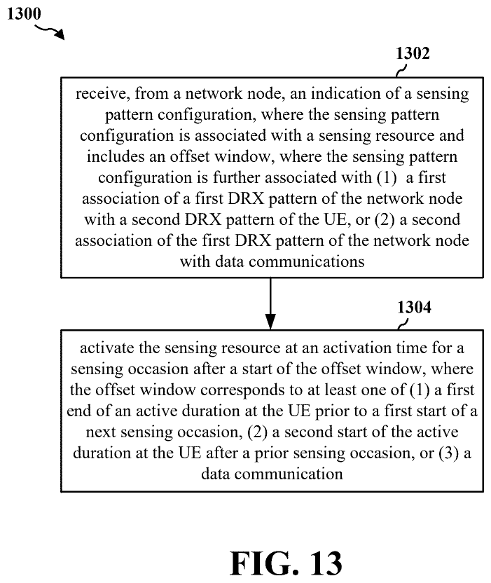

FIG. 13 is a flowchart 1300 of a method of wireless communication, in various aspects. The method may be performed by a UE (e.g., the UE 104, 404, UEs in 520/530, 612, 802; the apparatus 1704). In some aspects, the method may include aspects described in connection with the communication flow in FIG. 8 and/or aspects described in FIGS. 9-12. The method provides for joint resource allocation for UE power savings in JCS that enables configurations for sensing patterns and associations to data thereof by which power savings at the sensing device are realized while still providing for enhancements to data communications through sensing.

At 1302, a UE receives, from a network node, an indication of a sensing pattern configuration, where the sensing pattern configuration is associated with a sensing resource and includes an offset window, where the sensing pattern configuration is further associated with (1) a first association of a first discontinuous reception (DRX) pattern of the network node with a second DRX pattern of the UE, or (2) a second association of the first DRX pattern of the network node with data communications. As an example, the reception may be performed, at least in part, by the component 198. FIGS. 8-12 illustrate an example of the UE 802 receiving such an indication of a sensing pattern configuration from a network node (e.g., the base station 804).

For example, the base station 804 may be configured to provide/transmit, and the UE 802 may be configured to receive, the sensing pattern configuration 810 and/or an indication thereof. The base station 804 may configure (at 808) a sensing pattern configuration 810 for the UE 802, and the UE 802 may receive the sensing pattern configuration 810 from the base station 804. The sensing pattern configuration 810 may be associated with a sensing resource, e.g., of the UE 802, for a sensing occasion (e.g., 904, 914 in FIG. 9; 1004, 1004′, 1024, 1034, 1046 in FIG. 10; 1106, 1114 in FIG. 11; 1208, 1234, 1244 in FIG. 12) and may include an indicate the offset window (e.g., 916, 918 in FIG. 9; 1006, 1008 in FIG. 10; 1108, 1116 in FIG. 11; 1210 in FIG. 12), or another offset window (e.g., 916, 918 in FIG. 9; 1006, 1008 in FIG. 10; 1108, 1116 in FIG. 11; 1210 in FIG. 12), based on the capability indication 806. In aspects, the sensing pattern configuration 810 may be associated with (1) a first association of a first DRX pattern of the base station 804 with a second DRX pattern of the UE 802, or (2) a second association of the first DRX pattern of the base station 804 with data communications.

In aspects, the offset window (e.g., 916, 918 in FIG. 9; 1006, 1008 in FIG. 10; 1108, 1116 in FIG. 11; 1210 in FIG. 12) may be based on a minimum value and a maximum value that are indicated in the sensing pattern configuration 810. In such a configuration, the minimum value may be based on a switching capability of the UE 802 and may be associated with an offset between the offset window (e.g., 916, 918 in FIG. 9; 1006, 1008 in FIG. 10; 1108, 1116 in FIG. 11; 1210 in FIG. 12) and an active duration (e.g., 902, 912 in FIG. 9; 1002, 1022, 1032, 1042 in FIG. 10; 1102, 1112 in FIG. 11; 1202, 1232, 1242 in FIG. 12), e.g., for the DRX pattern at the UE 802. In such configurations, the maximum value may be based on a maximum time between consecutive sensing occasions (e.g., 904, 914 in FIG. 9; 1004, 1004′, 1024, 1034, 1046 in FIG. 10; 1106, 1114 in FIG. 11; 1208, 1234, 1244 in FIG. 12) the UE 802 (e.g., the time a UE waits until a next sensing occasion (e.g., 904, 914 in FIG. 9; 1004, 1004′, 1024, 1034, 1046 in FIG. 10; 1106, 1114 in FIG. 11; 1208, 1234, 1244 in FIG. 12)). In some aspects, the minimum value may be set to zero or approximately zero in the sensing pattern configuration 810 based on the switching capability of the UE 802 indicating a capability, e.g., via capability indication 806, for simultaneous processing of communication operations and sensing operations by the UE 802. In some aspects, the offset window (e.g., 916, 918 in FIG. 9; 1006, 1008 in FIG. 10; 1108, 1116 in FIG. 11; 1210 in FIG. 12) may be based on a minimum value indicated the sensing pattern configuration 810 and/or a data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12) associated with an active duration (e.g., 902, 912 in FIG. 9; 1002, 1022, 1032, 1042 in FIG. 10; 1102, 1112 in FIG. 11; 1202, 1232, 1242 in FIG. 12), e.g., of the DRX pattern. In such configurations, the minimum value may be based on a switching capability of the UE 802 and may be associated with an offset between the offset window (e.g., 916, 918 in FIG. 9; 1006, 1008 in FIG. 10; 1108, 1116 in FIG. 11; 1210 in FIG. 12) and the data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12).

At 1304, the UE activates the sensing resource at an activation time for a sensing occasion after a start of the offset window, where the offset window corresponds to at least one of (1) a first end of an active duration at the UE prior to a first start of a next sensing occasion, (2) a second start of the active duration at the UE after a prior sensing occasion, or (3) a data communication. As an example, the activation may be performed, at least in part, by the component 198. FIGS. 8-12 illustrate an example of the UE 802 activating such a sensing resource based on the sensing pattern configuration from the network node (e.g., the base station 804).

For example, the UE 802 may be configured to activate the sensing resource at an activation time for a sensing occasion (e.g., 904, 914 in FIG. 9; 1004, 1004′, 1024, 1034, 1046 in FIG. 10; 1106, 1114 in FIG. 11; 1208, 1234, 1244 in FIG. 12) after a beginning of the offset window (e.g., 916, 918 in FIG. 9; 1006, 1008 in FIG. 10; 1108, 1116 in FIG. 11; 1210 in FIG. 12), e.g., based on the sensing pattern configuration 810. In aspects, the offset window (e.g., 916, 918 in FIG. 9; 1006, 1008 in FIG. 10; 1108, 1116 in FIG. 11; 1210 in FIG. 12) may correspond to (1) a first end of an active duration (e.g., 902, 912 in FIG. 9; 1002, 1022, 1032, 1042 in FIG. 10; 1102, 1112 in FIG. 11; 1202, 1232, 1242 in FIG. 12) at the UE 802 prior to a first start of a next sensing occasion (e.g., 904, 914 in FIG. 9; 1004, 1004′, 1024, 1034, 1046 in FIG. 10; 1106, 1114 in FIG. 11; 1208, 1234, 1244 in FIG. 12), (2) a second start of the active duration (e.g., 902, 912 in FIG. 9; 1002, 1022, 1032, 1042 in FIG. 10; 1102, 1112 in FIG. 11; 1202, 1232, 1242 in FIG. 12) at the UE 802 after a prior sensing occasion (e.g., 904, 914 in FIG. 9; 1004, 1004′, 1024, 1034, 1046 in FIG. 10; 1106, 1114 in FIG. 11; 1208, 1234, 1244 in FIG. 12), and/or (3) a data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12).

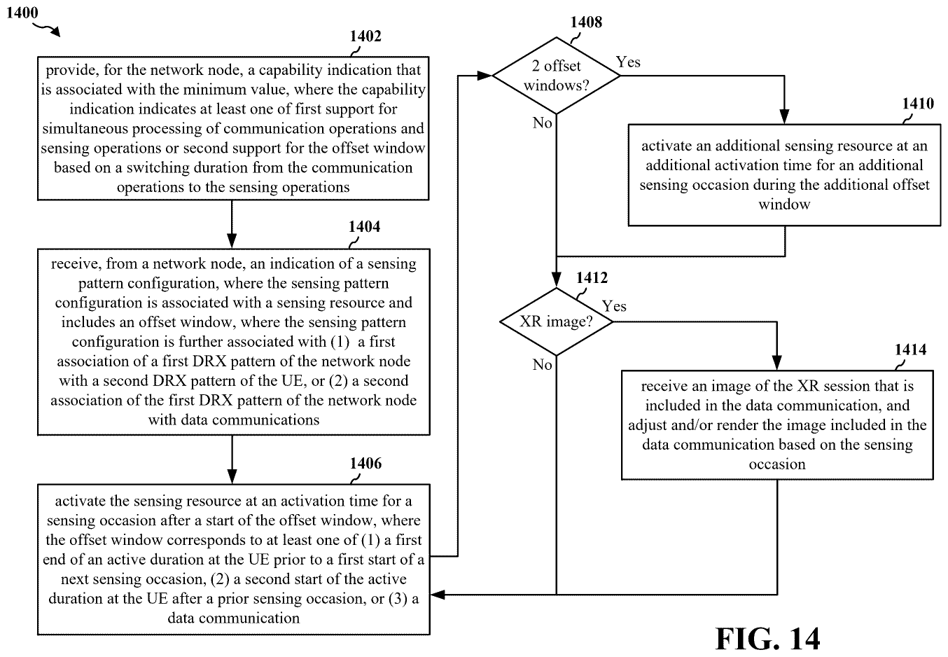

FIG. 14 is a flowchart 1400 of a method of wireless communication, in various aspects. The method may be performed by a UE (e.g., the UE 104, 404, UEs in 520/530, 612, 802; the apparatus 1704). In some aspects, the method may include aspects described in connection with the communication flow in FIG. 8 and/or aspects described in FIGS. 9-12. The method provides for joint resource allocation for UE power savings in JCS that enables configurations for sensing patterns and associations to data thereof by which power savings at the sensing device are realized while still providing for enhancements to data communications through sensing.

At 1402, the UE provides, for the network node, a capability indication that is associated with the minimum value, where the capability indication indicates at least one of first support for simultaneous processing of communication operations and sensing operations or second support for the offset window based on a switching duration from the communication operations to the sensing operations. As an example, the provision may be performed, at least in part, by the component 198. FIGS. 8-12 illustrate an example of the UE 802 providing such a capability indication for a network node (e.g., the base station 804).

For example, the UE 802 may provide, and the base station 804 may receive, a capability indication 806. The capability indication 806 may be associated with a minimum value for an offset window (e.g., 916, 918 in FIG. 9; 1006, 1008 in FIG. 10; 1108, 1116 in FIG. 11; 1210 in FIG. 12) utilized to determine activations of sensing resources as at sensing occasions (e.g., 904, 914 in FIG. 9; 1004, 1004′, 1024, 1034, 1046 in FIG. 10; 1106, 1114 in FIG. 11; 1208, 1234, 1244 in FIG. 12). The capability indication 806 may indicate first support for simultaneous processing of communications operations and sensing operations and/or second support for the offset window (e.g., 916, 918 in FIG. 9; 1006, 1008 in FIG. 10; 1108, 1116 in FIG. 11; 1210 in FIG. 12) based on a switching duration from the communications operations to the sensing operations.

At 1404, the UE receives, from a network node, an indication of a sensing pattern configuration, where the sensing pattern configuration is associated with a sensing resource and includes an offset window, where the sensing pattern configuration is further associated with (1) a first association of a first discontinuous reception (DRX) pattern of the network node with a second DRX pattern of the UE, or (2) a second association of the first DRX pattern of the network node with data communications. As an example, the reception may be performed, at least in part, by the component 198. FIGS. 8-12 illustrate an example of the UE 802 receiving such an indication of a sensing pattern configuration from a network node (e.g., the base station 804).

For example, the base station 804 may configure (at 808) a sensing pattern configuration 810 for the UE 802, and the UE 802 may receive the sensing pattern configuration 810 from the base station 804. The sensing pattern configuration 810 may be associated with a sensing resource, e.g., of the UE 802, for a sensing occasion (e.g., 904, 914 in FIG. 9; 1004, 1004′, 1024, 1034, 1046 in FIG. 10; 1106, 1114 in FIG. 11; 1208, 1234, 1244 in FIG. 12) and may include an indicate the offset window (e.g., 916, 918 in FIG. 9; 1006, 1008 in FIG. 10; 1108, 1116 in FIG. 11; 1210 in FIG. 12), or another offset window (e.g., 916, 918 in FIG. 9; 1006, 1008 in FIG. 10; 1108, 1116 in FIG. 11; 1210 in FIG. 12), based on the capability indication 806. In aspects, the sensing pattern configuration 810 may be associated with (1) a first association of a first DRX pattern of the base station 804 with a second DRX pattern of the UE 802, or (2) a second association of the first DRX pattern of the base station 804 with data communications.

In aspects, the offset window (e.g., 916, 918 in FIG. 9; 1006, 1008 in FIG. 10; 1108, 1116 in FIG. 11; 1210 in FIG. 12) may be based on a minimum value and a maximum value that are indicated in the sensing pattern configuration 810. In such a configuration, the minimum value may be based on a switching capability of the UE 802 and may be associated with an offset between the offset window (e.g., 916, 918 in FIG. 9; 1006, 1008 in FIG. 10; 1108, 1116 in FIG. 11; 1210 in FIG. 12) and an active duration (e.g., 902, 912 in FIG. 9; 1002, 1022, 1032, 1042 in FIG. 10; 1102, 1112 in FIG. 11; 1202, 1232, 1242 in FIG. 12), e.g., for the DRX pattern at the UE 802. In such configurations, the maximum value may be based on a maximum time between consecutive sensing occasions (e.g., 904, 914 in FIG. 9; 1004, 1004′, 1024, 1034, 1046 in FIG. 10; 1106, 1114 in FIG. 11; 1208, 1234, 1244 in FIG. 12) the UE 802 (e.g., the time a UE waits until a next sensing occasion (e.g., 904, 914 in FIG. 9; 1004, 1004′, 1024, 1034, 1046 in FIG. 10; 1106, 1114 in FIG. 11; 1208, 1234, 1244 in FIG. 12)). In some aspects, the minimum value may be set to zero or approximately zero in the sensing pattern configuration 810 based on the switching capability of the UE 802 indicating a capability, e.g., via capability indication 806, for simultaneous processing of communication operations and sensing operations by the UE 802. In some aspects, the offset window (e.g., 916, 918 in FIG. 9; 1006, 1008 in FIG. 10; 1108, 1116 in FIG. 11; 1210 in FIG. 12) may be based on a minimum value indicated the sensing pattern configuration 810 and/or a data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12) associated with an active duration (e.g., 902, 912 in FIG. 9; 1002, 1022, 1032, 1042 in FIG. 10; 1102, 1112 in FIG. 11; 1202, 1232, 1242 in FIG. 12), e.g., of the DRX pattern. In such configurations, the minimum value may be based on a switching capability of the UE 802 and may be associated with an offset between the offset window (e.g., 916, 918 in FIG. 9; 1006, 1008 in FIG. 10; 1108, 1116 in FIG. 11; 1210 in FIG. 12) and the data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12).

At 1406, the UE activates the sensing resource at an activation time for a sensing occasion after a start of the offset window, where the offset window corresponds to at least one of (1) a first end of an active duration at the UE prior to a first start of a next sensing occasion, (2) a second start of the active duration at the UE after a prior sensing occasion, or (3) a data communication. As an example, the activation may be performed, at least in part, by the component 198. FIGS. 8-12 illustrate an example of the UE 802 activating such a sensing resource based on the sensing pattern configuration from the network node (e.g., the base station 804).

For example, the UE 802 may be configured to activate the sensing resource at an activation time for a sensing occasion (e.g., 904, 914 in FIG. 9; 1004, 1004′, 1024, 1034, 1046 in FIG. 10; 1106, 1114 in FIG. 11; 1208, 1234, 1244 in FIG. 12) after a beginning of the offset window (e.g., 916, 918 in FIG. 9; 1006, 1008 in FIG. 10; 1108, 1116 in FIG. 11; 1210 in FIG. 12), e.g., based on the sensing pattern configuration 810. In aspects, the offset window (e.g., 916, 918 in FIG. 9; 1006, 1008 in FIG. 10; 1108, 1116 in FIG. 11; 1210 in FIG. 12) may correspond to (1) a first end of an active duration (e.g., 902, 912 in FIG. 9; 1002, 1022, 1032, 1042 in FIG. 10; 1102, 1112 in FIG. 11; 1202, 1232, 1242 in FIG. 12) at the UE 802 prior to a first start of a next sensing occasion (e.g., 904, 914 in FIG. 9; 1004, 1004′, 1024, 1034, 1046 in FIG. 10; 1106, 1114 in FIG. 11; 1208, 1234, 1244 in FIG. 12), (2) a second start of the active duration (e.g., 902, 912 in FIG. 9; 1002, 1022, 1032, 1042 in FIG. 10; 1102, 1112 in FIG. 11; 1202, 1232, 1242 in FIG. 12) at the UE 802 after a prior sensing occasion (e.g., 904, 914 in FIG. 9; 1004, 1004′, 1024, 1034, 1046 in FIG. 10; 1106, 1114 in FIG. 11; 1208, 1234, 1244 in FIG. 12), and/or (3) a data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12).

At 1408, the UE determines if the sensing pattern configuration indicates that two offset windows are configured. As an example, the determination may be performed, at least in part, by the component 198. If so, the flowchart 1400 continues to 1410; if not, the flowchart 1400 continues to 1412.

At 1410, the UE activates an additional sensing resource at an additional activation time for an additional sensing occasion during the additional offset window. As an example, the activation may be performed, at least in part, by the component 198. FIGS. 8-12 illustrate an example of the UE 802 activating such an additional sensing resource based on the sensing pattern configuration from the network node (e.g., the base station 804).

For example, as part of the activating at 812, the UE 802 may be configured to activate an additional sensing resource at an additional activation time for an additional sensing occasion (e.g., 904, 914 in FIG. 9; 1004, 1004′, 1024, 1034, 1046 in FIG. 10; 1106, 1114 in FIG. 11; 1208, 1234, 1244 in FIG. 12), during the additional offset window (e.g., 916, 918 in FIG. 9; 1006, 1008 in FIG. 10; 1108, 1116 in FIG. 11; 1210 in FIG. 12), e.g., as illustrated by way of example in the configuration 1010 in FIG. 10 (e.g., the first on of sensing occasions 1004, 1004′).

At 1412, the UE determines if new DL data traffic (e.g., an XR image) is received. As an example, the determination may be performed, at least in part, by the component 198. If so, the flowchart 1400 may continue back to 1406 for a next sensing occasion instance; if not, the flowchart 1400 continues to 1414.

At 1414, the UE receive an image of the XR session that is included in the data communication, and adjusts and/or renders the image included in the data communication based on the sensing occasions. As an example, the reception may be performed, at least in part, by the component 198. FIGS. 8-12 illustrate an example of the UE 802 receiving such an image and adjusting/rendering the image.

For example, sensing may be performed to enhance the XR performance, according to aspects. As examples, a sensing device, such as the UE 802, may sense the pose or gesture(s) of a user before data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12) starts, or may sense after data reception for application layer processing of data based on spatial information of the UE 802. The configuration 1220 illustrate, by way of example and not limitation, performing sensing after a data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12). For example, in an active duration 1202 (onDuration) (e.g., 902, 912 in FIG. 9; 1002, 1022, 1032, 1042 in FIG. 10; 1102, 1112 in FIG. 11; 1202, 1232, 1242 in FIG. 12), the UE may receive the latest DL data traffic (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12), e.g., an image, for display by the UE. The DL data traffic (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12) may be associated with a PDCCH DL grant 1204 for reception of the data via a PDSCH 1206. In some cases, such an image may be out of date, e.g., as compared to the real-time UE actions. Aspects herein enable the UE to enable/activate a sensing occasion 1208 (e.g., 904, 914 in FIG. 9; 1004, 1004′, 1024, 1034, 1046 in FIG. 10; 1106, 1114 in FIG. 11; 1208, 1234, 1244 in FIG. 12), e.g., after an offset 1210 (as described herein), to obtain up-to-date sensing information associated with the image received in the DL data traffic (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12). In aspects, this process may be similar to that as described above and shown for FIG. 10 (such as in the configuration 1020, the configuration 1030, the configuration 1040, and/or the like). That is, when there is new DL data traffic (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12) received, a following sensing occasion (e.g., the sensing occasion 1208) (e.g., 904, 914 in FIG. 9; 1004, 1004′, 1024, 1034, 1046 in FIG. 10; 1106, 1114 in FIG. 11; 1208, 1234, 1244 in FIG. 12) may be enabled.

As an example, but without limitation and with reference to FIG. 12 (e.g., the configuration 1220), after the image reception in the PDSCH 1206, a sensing operation via the sensing occasion 1208 may further detect/track new or more recent user actions. Accordingly, aspects herein enhance XR applications and processes by lightly and locally adjusting/rendering 1212 the image to better match the real-time scenarios for XR. That is, by way of example, a UE may wake up from a sleep state and switch to an active state in the active duration 1202 to obtain the PDCCH DL grant 1204 to receive the DL data traffic in the PDSCH 1206. After the end of the active duration 1202, the UE may switch back to the sleep state in the communication. After the offset 1210, the UE may perform monostatic sensing in the sensing occasion 1208 to detect the actions, e.g., body motions, gestures, etc., of users. Based on the new actions detected via the sensing, the UE may be configured to adjust/render 1212 the image to match the real-time scenarios, and then display the new image at the UE for a user(s).

From 1414, the flowchart 1400 may continue back to 1406 for a next sensing occasion instance.

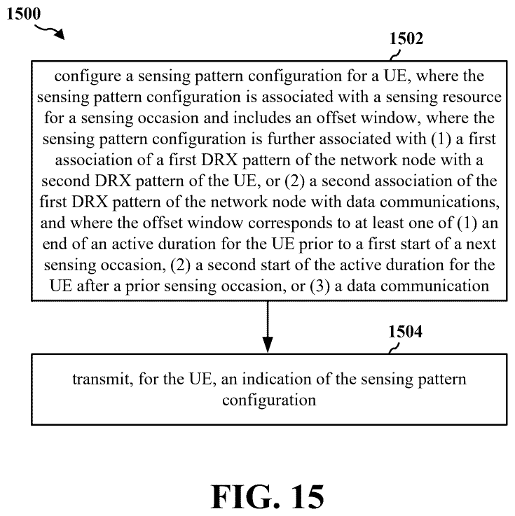

FIG. 15 is a flowchart 1500 of a method of wireless communication, in various aspects. The method may be performed by a base station (e.g., the base station 102, base stations in 520/530, 804; the network entity 614, 1702, 1802. In some aspects, the method may include aspects described in connection with the communication flow in FIG. 8 and/or aspects described in FIGS. 9-12. The method provides for joint resource allocation for UE power savings in JCS that enables configurations for sensing patterns and associations to data thereof by which power savings at the sensing device are realized while still providing for enhancements to data communications through sensing.

At 1502, a network node configures a sensing pattern configuration for a user equipment (UE), where the sensing pattern configuration is associated with a sensing resource for a sensing occasion and includes an offset window, where the sensing pattern configuration is further associated with (1) a first association of a first discontinuous reception (DRX) pattern of the network node with a second DRX pattern of the UE, or (2) a second association of the first DRX pattern of the network node with data communications, and where the offset window corresponds to at least one of (1) an end of an active duration for the UE prior to a first start of a next sensing occasion, (2) a second start of the active duration for the UE after a prior sensing occasion, or (3) a data communication. As an example, the configuration may be performed, at least in part, by the component 199. FIGS. 8-12 illustrate an example of the base station 804 configuring such a sensing pattern configuration for a UE (e.g., the UE 802).

For example, the base station 804 may configure (at 808) a sensing pattern configuration 810 for the UE 802. The sensing pattern configuration 810 may be associated with a sensing resource, e.g., of the UE 802, for a sensing occasion (e.g., 904, 914 in FIG. 9; 1004, 1004′, 1024, 1034, 1046 in FIG. 10; 1106, 1114 in FIG. 11; 1208, 1234, 1244 in FIG. 12) and may include an indicate the offset window (e.g., 916, 918 in FIG. 9; 1006, 1008 in FIG. 10; 1108, 1116 in FIG. 11; 1210 in FIG. 12), or another offset window (e.g., 916, 918 in FIG. 9; 1006, 1008 in FIG. 10; 1108, 1116 in FIG. 11; 1210 in FIG. 12), based on the capability indication 806. In aspects, the sensing pattern configuration 810 may be associated with (1) a first association of a first DRX pattern of the base station 804 with a second DRX pattern of the UE 802, or (2) a second association of the first DRX pattern of the base station 804 with data communications.

In aspects, the offset window (e.g., 916, 918 in FIG. 9; 1006, 1008 in FIG. 10; 1108, 1116 in FIG. 11; 1210 in FIG. 12) may be based on a minimum value and a maximum value that are indicated in the sensing pattern configuration 810. In such a configuration, the minimum value may be based on a switching capability of the UE 802 and may be associated with an offset between the offset window (e.g., 916, 918 in FIG. 9; 1006, 1008 in FIG. 10; 1108, 1116 in FIG. 11; 1210 in FIG. 12) and an active duration (e.g., 902, 912 in FIG. 9; 1002, 1022, 1032, 1042 in FIG. 10; 1102, 1112 in FIG. 11; 1202, 1232, 1242 in FIG. 12), e.g., for the DRX pattern at the UE 802. In such configurations, the maximum value may be based on a maximum time between consecutive sensing occasions (e.g., 904, 914 in FIG. 9; 1004, 1004′, 1024, 1034, 1046 in FIG. 10; 1106, 1114 in FIG. 11; 1208, 1234, 1244 in FIG. 12) the UE 802 (e.g., the time a UE waits until a next sensing occasion (e.g., 904, 914 in FIG. 9; 1004, 1004′, 1024, 1034, 1046 in FIG. 10; 1106, 1114 in FIG. 11; 1208, 1234, 1244 in FIG. 12). In some aspects, the minimum value may be set to zero or approximately zero in the sensing pattern configuration 810 based on the switching capability of the UE 802 indicating a capability, e.g., via capability indication 806, for simultaneous processing of communication operations and sensing operations by the UE 802. In some aspects, the offset window (e.g., 916, 918 in FIG. 9; 1006, 1008 in FIG. 10; 1108, 1116 in FIG. 11; 1210 in FIG. 12) may be based on a minimum value indicated the sensing pattern configuration 810 and/or a data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12) associated with an active duration (e.g., 902, 912 in FIG. 9; 1002, 1022, 1032, 1042 in FIG. 10; 1102, 1112 in FIG. 11; 1202, 1232, 1242 in FIG. 12), e.g., of the DRX pattern. In such configurations, the minimum value may be based on a switching capability of the UE 802 and may be associated with an offset between the offset window (e.g., 916, 918 in FIG. 9; 1006, 1008 in FIG. 10; 1108, 1116 in FIG. 11; 1210 in FIG. 12) and the data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12).

At 1504, the network node transmits, for the UE, an indication of the sensing pattern configuration. As an example, the transmission may be performed, at least in part, by the component 199. FIGS. 8-12 illustrate an example of the base station 804 providing such a transmission for a UE (e.g., the UE 802).

For example, the base station 804 may be configured to provide/transmit, and the UE 802 may be configured to receive, the sensing pattern configuration 810 and/or an indication thereof. The UE 802 may be configured to activate the sensing resource at an activation time for a sensing occasion (e.g., 904, 914 in FIG. 9; 1004, 1004′, 1024, 1034, 1046 in FIG. 10; 1106, 1114 in FIG. 11; 1208, 1234, 1244 in FIG. 12) after a beginning of the offset window (e.g., 916, 918 in FIG. 9; 1006, 1008 in FIG. 10; 1108, 1116 in FIG. 11; 1210 in FIG. 12), e.g., based on the sensing pattern configuration 810. In aspects, the offset window (e.g., 916, 918 in FIG. 9; 1006, 1008 in FIG. 10; 1108, 1116 in FIG. 11; 1210 in FIG. 12) may correspond to (1) a first end of an active duration (e.g., 902, 912 in FIG. 9; 1002, 1022, 1032, 1042 in FIG. 10; 1102, 1112 in FIG. 11; 1202, 1232, 1242 in FIG. 12) at the UE 802 prior to a first start of a next sensing occasion (e.g., 904, 914 in FIG. 9; 1004, 1004′, 1024, 1034, 1046 in FIG. 10; 1106, 1114 in FIG. 11; 1208, 1234, 1244 in FIG. 12), (2) a second start of the active duration (e.g., 902, 912 in FIG. 9; 1002, 1022, 1032, 1042 in FIG. 10; 1102, 1112 in FIG. 11; 1202, 1232, 1242 in FIG. 12) at the UE 802 after a prior sensing occasion (e.g., 904, 914 in FIG. 9; 1004, 1004′, 1024, 1034, 1046 in FIG. 10; 1106, 1114 in FIG. 11; 1208, 1234, 1244 in FIG. 12), and/or (3) a data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12).

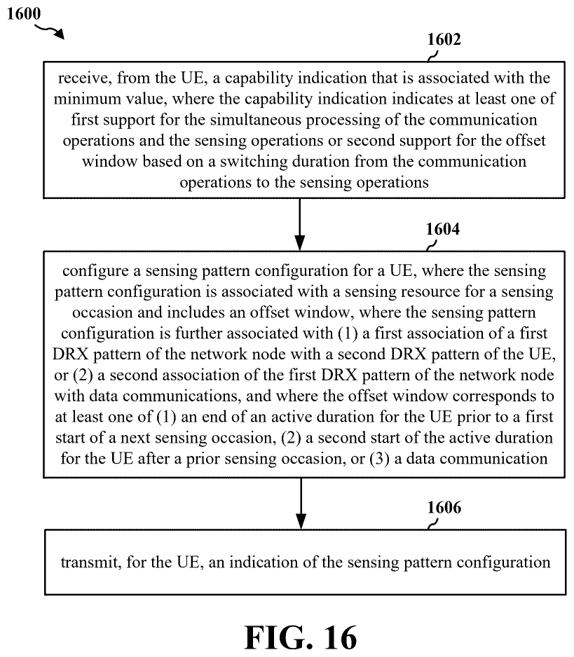

FIG. 16 is a flowchart 1600 of a method of wireless communication, in various aspects. The method may be performed by a base station (e.g., the base station 102, base stations in 520/530, 804; the network entity 614, 1702, 1802. In some aspects, the method may include aspects described in connection with the communication flow in FIG. 8 and/or aspects described in FIGS. 9-12. The method provides for joint resource allocation for UE power savings in JCS that enables configurations for sensing patterns and associations to data thereof by which power savings at the sensing device are realized while still providing for enhancements to data communications through sensing.

At 1602, a network node receives, from the UE, a capability indication that is associated with the minimum value, where the capability indication indicates at least one of first support for the simultaneous processing of the communication operations and the sensing operations or second support for the offset window based on a switching duration from the communication operations to the sensing operations. As an example, the reception may be performed, at least in part, by the component 199. FIGS. 8-12 illustrate an example of the base station 804 receiving such a capability indication from a UE (e.g., the UE 802).

For example, the UE 802 may provide, and the base station 804 may receive, a capability indication 806. The capability indication 806 may be associated with a minimum value for an offset window (e.g., 916, 918 in FIG. 9; 1006, 1008 in FIG. 10; 1108, 1116 in FIG. 11; 1210 in FIG. 12) utilized to determine activations of sensing resources as at sensing occasions (e.g., 904, 914 in FIG. 9; 1004, 1004′, 1024, 1034, 1046 in FIG. 10; 1106, 1114 in FIG. 11; 1208, 1234, 1244 in FIG. 12). The capability indication 806 may indicate first support for simultaneous processing of communications operations and sensing operations and/or second support for the offset window (e.g., 916, 918 in FIG. 9; 1006, 1008 in FIG. 10; 1108, 1116 in FIG. 11; 1210 in FIG. 12) based on a switching duration from the communications operations to the sensing operations.

At 1604, the network node configures a sensing pattern configuration for a user equipment (UE), where the sensing pattern configuration is associated with a sensing resource for a sensing occasion and includes an offset window, where the sensing pattern configuration is further associated with (1) a first association of a first discontinuous reception (DRX) pattern of the network node with a second DRX pattern of the UE, or (2) a second association of the first DRX pattern of the network node with data communications, and where the offset window corresponds to at least one of (1) an end of an active duration for the UE prior to a first start of a next sensing occasion, (2) a second start of the active duration for the UE after a prior sensing occasion, or (3) a data communication. As an example, the configuration may be performed, at least in part, by the component 199. FIGS. 8-12 illustrate an example of the base station 804 configuring such a sensing pattern configuration for a UE (e.g., the UE 802).

For example, the base station 804 may configure (at 808) a sensing pattern configuration 810 for the UE 802. The sensing pattern configuration 810 may be associated with a sensing resource, e.g., of the UE 802, for a sensing occasion (e.g., 904, 914 in FIG. 9; 1004, 1004′, 1024, 1034, 1046 in FIG. 10; 1106, 1114 in FIG. 11; 1208, 1234, 1244 in FIG. 12) and may include an indicate the offset window (e.g., 916, 918 in FIG. 9; 1006, 1008 in FIG. 10; 1108, 1116 in FIG. 11; 1210 in FIG. 12), or another offset window (e.g., 916, 918 in FIG. 9; 1006, 1008 in FIG. 10; 1108, 1116 in FIG. 11; 1210 in FIG. 12), based on the capability indication 806. In aspects, the sensing pattern configuration 810 may be associated with (1) a first association of a first DRX pattern of the base station 804 with a second DRX pattern of the UE 802, or (2) a second association of the first DRX pattern of the base station 804 with data communications.

In aspects, the offset window (e.g., 916, 918 in FIG. 9; 1006, 1008 in FIG. 10; 1108, 1116 in FIG. 11; 1210 in FIG. 12) may be based on a minimum value and a maximum value that are indicated in the sensing pattern configuration 810. In such a configuration, the minimum value may be based on a switching capability of the UE 802 and may be associated with an offset between the offset window (e.g., 916, 918 in FIG. 9; 1006, 1008 in FIG. 10; 1108, 1116 in FIG. 11; 1210 in FIG. 12) and an active duration (e.g., 902, 912 in FIG. 9; 1002, 1022, 1032, 1042 in FIG. 10; 1102, 1112 in FIG. 11; 1202, 1232, 1242 in FIG. 12), e.g., for the DRX pattern at the UE 802. In such configurations, the maximum value may be based on a maximum time between consecutive sensing occasions (e.g., 904, 914 in FIG. 9; 1004, 1004′, 1024, 1034, 1046 in FIG. 10; 1106, 1114 in FIG. 11; 1208, 1234, 1244 in FIG. 12) the UE 802 (e.g., the time a UE waits until a next sensing occasion (e.g., 904, 914 in FIG. 9; 1004, 1004′, 1024, 1034, 1046 in FIG. 10; 1106, 1114 in FIG. 11; 1208, 1234, 1244 in FIG. 12)). In some aspects, the minimum value may be set to zero or approximately zero in the sensing pattern configuration 810 based on the switching capability of the UE 802 indicating a capability, e.g., via capability indication 806, for simultaneous processing of communication operations and sensing operations by the UE 802. In some aspects, the offset window (e.g., 916, 918 in FIG. 9; 1006, 1008 in FIG. 10; 1108, 1116 in FIG. 11; 1210 in FIG. 12) may be based on a minimum value indicated the sensing pattern configuration 810 and/or a data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12) associated with an active duration (e.g., 902, 912 in FIG. 9; 1002, 1022, 1032, 1042 in FIG. 10; 1102, 1112 in FIG. 11; 1202, 1232, 1242 in FIG. 12), e.g., of the DRX pattern. In such configurations, the minimum value may be based on a switching capability of the UE 802 and may be associated with an offset between the offset window (e.g., 916, 918 in FIG. 9; 1006, 1008 in FIG. 10; 1108, 1116 in FIG. 11; 1210 in FIG. 12) and the data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12).

At 1606, the network node transmits, for the UE, an indication of the sensing pattern configuration. As an example, the transmission may be performed, at least in part, by the component 199. FIGS. 8-12 illustrate an example of the base station 804 providing such a transmission for a UE (e.g., the UE 802).

For example, the base station 804 may be configured to provide/transmit, and the UE 802 may be configured to receive, the sensing pattern configuration 810 and/or an indication thereof. The UE 802 may be configured to activate the sensing resource at an activation time for a sensing occasion (e.g., 904, 914 in FIG. 9; 1004, 1004′, 1024, 1034, 1046 in FIG. 10; 1106, 1114 in FIG. 11; 1208, 1234, 1244 in FIG. 12) after a beginning of the offset window (e.g., 916, 918 in FIG. 9; 1006, 1008 in FIG. 10; 1108, 1116 in FIG. 11; 1210 in FIG. 12), e.g., based on the sensing pattern configuration 810. In aspects, the offset window (e.g., 916, 918 in FIG. 9; 1006, 1008 in FIG. 10; 1108, 1116 in FIG. 11; 1210 in FIG. 12) may correspond to (1) a first end of an active duration (e.g., 902, 912 in FIG. 9; 1002, 1022, 1032, 1042 in FIG. 10; 1102, 1112 in FIG. 11; 1202, 1232, 1242 in FIG. 12) at the UE 802 prior to a first start of a next sensing occasion (e.g., 904, 914 in FIG. 9; 1004, 1004′, 1024, 1034, 1046 in FIG. 10; 1106, 1114 in FIG. 11; 1208, 1234, 1244 in FIG. 12), (2) a second start of the active duration (e.g., 902, 912 in FIG. 9; 1002, 1022, 1032, 1042 in FIG. 10; 1102, 1112 in FIG. 11; 1202, 1232, 1242 in FIG. 12) at the UE 802 after a prior sensing occasion (e.g., 904, 914 in FIG. 9; 1004, 1004′, 1024, 1034, 1046 in FIG. 10; 1106, 1114 in FIG. 11; 1208, 1234, 1244 in FIG. 12), and/or (3) a data communication (e.g., 902, 912 in FIG. 9; 1002, 1022, 1032, 1042, 1044 in FIG. 10; 1102, 1104, 1112 in FIG. 11; 1202, 1204, 1206, 1232, 1242 in FIG. 12).

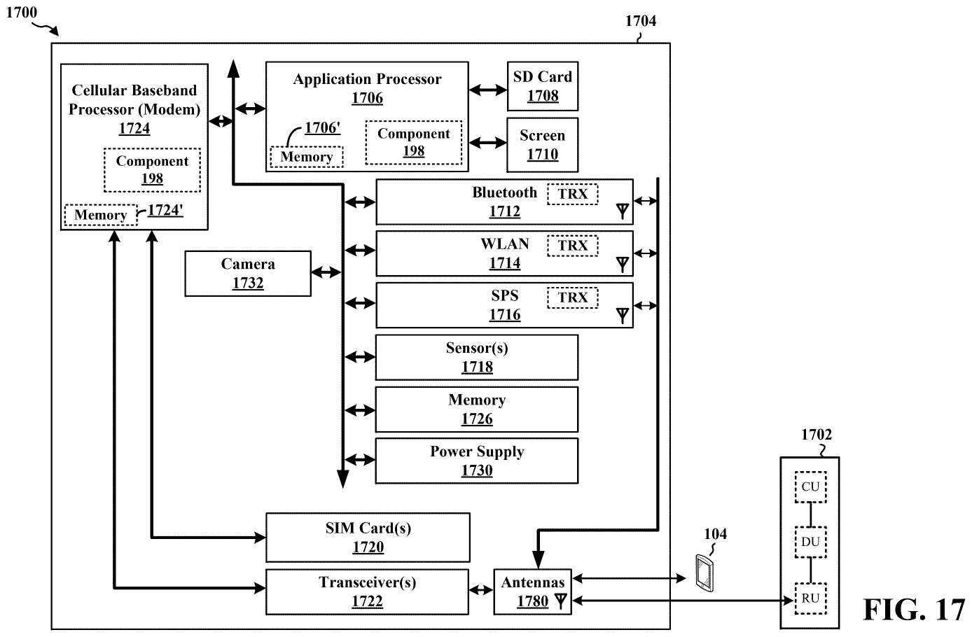

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see UE 350 of FIG. 3) and include the additional modules of the apparatus 1704.

As discussed supra, the component 198 may be configured to receive, from a network node, an indication of a sensing pattern configuration, where the sensing pattern configuration is associated with a sensing resource and includes an offset window, where the sensing pattern configuration is further associated with (1) a first association of a first DRX pattern of the network node with a second DRX pattern of the UE, or (2) a second association of the first DRX pattern of the network node with data communications. The component 198 may also be configured to activate the sensing resource at an activation time for a sensing occasion after a start of the offset window, where the offset window corresponds to at least one of (1) a first end of an active duration at the UE prior to a first start of a next sensing occasion, (2) a second start of the active duration at the UE after a prior sensing occasion, or (3) a data communication. The component 198 may be configured to provide, for the network node, a capability indication that is associated with the minimum value, where the capability indication indicates at least one of first support for simultaneous processing of communication operations and sensing operations or second support for the offset window based on a switching duration from the communication operations to the sensing operations. The component 198 may be configured to activate an additional sensing resource at an additional activation time for an additional sensing occasion during the additional offset window. The component 198 may be configured to receive an image of the XR session that is included in the data communication. The component 198 may be configured to adjust or render the image included in the data communication based on the sensing occasion. The component 198 may be further configured to perform any of the aspects described in connection with the flowcharts in any of FIGS. 13-16, and/or any of the aspects performed by a sensing node for any of FIGS. 5-12. The component 198 may be within the cellular baseband processor 1724, the application processor 1706, or both the cellular baseband processor 1724 and the application processor 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, may include means for receiving, from a network node, an indication of a sensing pattern configuration, where the sensing pattern configuration is associated with a sensing resource and includes an offset window, where the sensing pattern configuration is further associated with (1) a first association of a first DRX pattern of the network node with a second DRX pattern of the UE, or (2) a second association of the first DRX pattern of the network node with data communications. In the configuration, the apparatus 1704, and in particular the cellular baseband processor 1724 and/or the application processor 1706, may include means for activating the sensing resource at an activation time for a sensing occasion after a start of the offset window, where the offset window corresponds to at least one of (1) a first end of an active duration at the UE prior to a first start of a next sensing occasion, (2) a second start of the active duration at the UE after a prior sensing occasion, or (3) a data communication. In one configuration, the apparatus 1704, and in particular the cellular baseband processor 1724 and/or the application processor 1706, may include means for providing, for the network node, a capability indication that is associated with the minimum value, where the capability indication indicates at least one of first support for simultaneous processing of communication operations and sensing operations or second support for the offset window based on a switching duration from the communication operations to the sensing operations. In one configuration, the apparatus 1704, and in particular the cellular baseband processor 1724 and/or the application processor 1706, may include means for activating an additional sensing resource at an additional activation time for an additional sensing occasion during the additional offset window. In one configuration, the apparatus 1704, and in particular the cellular baseband processor 1724 and/or the application processor 1706, may include means for receiving an image of the XR session that is included in the data communication. In one configuration, the apparatus 1704, and in particular the cellular baseband processor 1724 and/or the application processor 1706, may include means for adjusting or rendering the image included in the data communication based on the sensing occasion. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

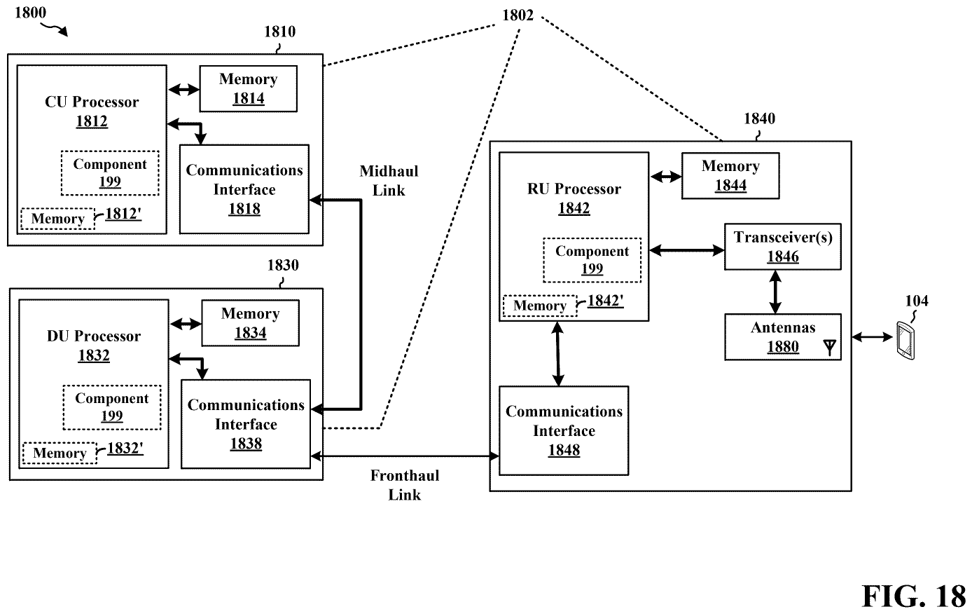

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a sensing pattern configuration for a UE, where the sensing pattern configuration is associated with a sensing resource for a sensing occasion and includes an offset window, where the sensing pattern configuration is further associated with (1) a first association of a first DRX pattern of the network node with a second DRX pattern of the UE, or (2) a second association of the first DRX pattern of the network node with data communications, and where the offset window corresponds to at least one of (1) an end of an active duration for the UE prior to a first start of a next sensing occasion, (2) a second start of the active duration for the UE after a prior sensing occasion, or (3) a data communication. The component 199 may also be configured to transmit, for the UE, an indication of the sensing pattern configuration. The component 199 may be configured to receive, from the UE, a capability indication that is associated with the minimum value, where the capability indication indicates at least one of first support for the simultaneous processing of the communication operations and the sensing operations or second support for the offset window based on a switching duration from the communication operations to the sensing operations. The component 199 may be further configured to perform any of the aspects described in connection with the flowcharts in any of FIGS. 13-16, and/or any of the aspects performed by a sensing node for any of FIGS. 5-12. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 may include means for configuring a sensing pattern configuration for a UE, where the sensing pattern configuration is associated with a sensing resource for a sensing occasion and includes an offset window, where the sensing pattern configuration is further associated with (1) a first association of a first DRX pattern of the network node with a second DRX pattern of the UE, or (2) a second association of the first DRX pattern of the network node with data communications, and where the offset window corresponds to at least one of (1) an end of an active duration for the UE prior to a first start of a next sensing occasion, (2) a second start of the active duration for the UE after a prior sensing occasion, or (3) a data communication. In the configuration, the network entity 1802 may include means for transmitting, for the UE, an indication of the sensing pattern configuration. In one configuration, the network entity 1802 may include means for receiving, from the UE, a capability indication that is associated with the minimum value, where the capability indication indicates at least one of first support for the simultaneous processing of the communication operations and the sensing operations or second support for the offset window based on a switching duration from the communication operations to the sensing operations. The means may be the component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

Traffic flows may have various characteristics in wireless communication networks, e.g., including layer attributes, timeframes for latency, etc. As an example, extended reality (XR) traffic for UL and DL may have characteristics such as application layer attributes, short timeframes for exchange where longer latency for traffic flows may reduce a user experience with an XR application or device, etc. XR traffic bursts may be periodic but may include some time jitter in their arrival, and the XR packet sizes, and the number of packets, for certain bursts may be variable. That is, XR service characteristics such as periodicity, multiple flows, jitter, latency, reliability, etc., may affect signaling throughput, latency, and other operations at base stations and other devices such as UEs on a wireless communication network. Additionally, XR operations/applications may utilize sensing, e.g., RF sensing, to sense environments in which a UE, terminal, access point, etc., is located. However, existing configurations/implementations do not provide for enabling sensing in DRX, e.g., for XR, with additional power savings, and when XR is enabled with JCS, sensing configurations may not enhance XR performance. Further, in XR, traffic patterns may be impacted by latency constraints and the actions of users, e.g., pose, gestures, etc. Therefore, DRX patterns may not conform to static expectations, e.g., one uniform distribution of the onDuration in time. Accordingly, configuring sensing resources in this context may be problematic.

Various aspects herein may provide reductions in power consumption at the sensing device (e.g., a UE, etc.) while still improving communications via sensing (e.g., for XR) by activating sensing occasions that align with DRX pattern on/active durations for joint resource configurations. Various aspects may also indicate individual sensing occasions, configure pre-defined sensing patterns, further enhance communications with sensing, and maintain phase coherency for sensing occasions by activating sensing occasions that align with DRX pattern on/active durations for JCS based on alignment rules.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), including: receiving, from a network node, an indication of a sensing pattern configuration, where the sensing pattern configuration is associated with a sensing resource and includes an offset window, where the sensing pattern configuration is further associated with (1) a first association of a first discontinuous reception (DRX) pattern of the network node with a second DRX pattern of the UE, or (2) a second association of the first DRX pattern of the network node with data communications; and activating the sensing resource at an activation time for a sensing occasion after a start of the offset window, where the offset window corresponds to at least one of (1) a first end of an active duration at the UE prior to a first start of a next sensing occasion, (2) a second start of the active duration at the UE after a prior sensing occasion, or (3) a data communication.

Aspect 2 is the method of aspect 1, where the offset window is based on a minimum value and a maximum value that are indicated in the sensing pattern configuration, where the minimum value is based on a switching capability of the UE and is associated with an offset between the offset window and the active duration, and where the maximum value is based on a maximum time between consecutive sensing occasions at the UE.

Aspect 3 is the method of aspect 2, where the minimum value is set to zero or approximately zero in the sensing pattern configuration based on the switching capability of the UE indicating a capability for simultaneous processing of communication operations and sensing operations by the UE.

Aspect 4 is the method of and of aspects 2 and 3, further including: providing, for the network node, a capability indication that is associated with the minimum value, where the capability indication indicates at least one of first support for simultaneous processing of communication operations and sensing operations or second support for the offset window based on a switching duration from the communication operations to the sensing operations.

Aspect 5 is the method of aspect 2, where an additional offset window is associated with another of the at least one of (1) the first end of the active duration at the UE prior to the first start of the next sensing occasion or (2) the second start of the active duration at the UE after the prior sensing occasion; and where the sensing pattern configuration indicates at least one of: a prior minimum value for the offset window or the additional offset window that is based on the switching capability of the UE from sensing operations to communication operations and is associated with an additional offset between the additional offset window and the active duration that is prior to the active duration; the minimum value being associated with the offset between the offset window and the active duration that is after the active duration; or the maximum value also being associated with the additional offset window.

Aspect 6 is the method of aspect 5, where activating the sensing resource at the activation time for the sensing occasion during the offset window includes: activating an additional sensing resource at an additional activation time for an additional sensing occasion during the additional offset window.

Aspect 7 is the method of aspect 1, where the offset window is based on a minimum value indicated in at least one of the sensing pattern configuration or the data communication associated with the active duration, where the minimum value is based on a switching capability of the UE and is associated with an offset between the offset window and the data communication.

Aspect 8 is the method of aspect 7, where the offset corresponds to at least one of: a second end of the data communication, where the data communication includes control data in the active duration and an activation indication included in the control data; the second end of the data communication, where the data communication includes the control data in the active duration; or the second end of the data communication, where the data communication is in the active duration and includes new downlink (DL) data traffic.

Aspect 9 is the method of any of aspects 7 and 8, where the minimum value is indicated in the sensing pattern configuration and is a first value that corresponds to the switching capability; or where the minimum value is indicated in the control data included in the data communication and is a second value that is greater than or equal to the first value.

Aspect 10 is the method of any of aspects 7 to 9, where the sensing resource is associated with bistatic sensing and is within the active duration, and where the sensing pattern configuration indicates at least one of: a first activity timer and a first inactivity timer that are associated with a set of DRX cycles of the first DRX pattern of the network node, where a DRX cycle of the set of DRX cycles includes the active duration and a sleep state of the UE that is after the active duration, and where the active duration is bounded according to the first activity timer; a second activity timer and a second inactivity timer that are respectively longer than the first activity timer and the first inactivity timer, where the DRX cycle includes the active duration and the sleep state of the UE that is after the active duration, and where the active duration is bounded according to the second activity timer; or a sensing timer that is based on a length of the sensing occasion, where the active duration is bounded by a first combined length of the first inactivity timer, the offset, and the sensing timer, and where an inactivity time of the active duration is bounded by a second combined length of the first inactivity timer, the offset, and the sensing timer.

Aspect 11 is the method of any of aspects 7 to 9, where the sensing resource is associated with monostatic sensing and is after the active duration during a sleep state of the UE, where a communication resource associated with the data communication in the active duration is reused as the sensing resource after the offset, and where activating the sensing resource at the activation time for the sensing occasion includes activating the sensing resource based on the monostatic sensing.

Aspect 12 is the method of aspect 11, where the data communication in the active duration includes at least one of a medium access control (MAC) control element (MAC-CE) or downlink control information (DCI) that indicates the reuse of the communication resource associated with the data communication as the sensing resource.

Aspect 13 is the method of aspect 7, where the sensing resource is associated with monostatic sensing and is after the active duration during a sleep state of the UE, where the offset corresponds to at least one of: a second end of the data communication, where the data communication includes control data in the active duration and an activation indication included in the control data; the second end of the data communication, where the data communication includes the control data in the active duration; or the second end of the data communication, where the data communication is in the active duration and includes new downlink (DL) data traffic.

Aspect 14 is the method of aspect 7, where the offset window included in the sensing pattern configuration corresponds to each of the second start of the active duration at the UE after the prior sensing occasion and a start of the data communication, where the offset between the offset window and the data communication is prior to the data communication.

Aspect 15 is the method of aspect 1, where the sensing occasion and the data communication are associated with an extended reality (XR) session and the data communication includes downlink (DL) XR data traffic; where the offset window is based on a minimum value associated with a switching capability of the UE, where the minimum value is indicated in the sensing pattern configuration associated with the active duration; where the minimum value is associated with an offset that is (1) after the data communication and between the offset window and the data communication, or (2) prior to the second start of the active duration at the UE that includes the data communication.

Aspect 16 is the method of aspect 15, further including: receiving an image of the XR session that is included in the data communication; and adjusting or rendering the image included in the data communication based on the sensing occasion.

Aspect 17 is the method of aspect 16, where the data communication is associated a downlink (DL) grant from the network node, where the sensing occasion is a monostatic sensing occasion; or where the sensing occasion is associated with a non-integer periodicity for the XR session, and where the non-integer periodicity is indicated in the sensing pattern configuration.

Aspect 18 is the method of any of aspects 1 to 17, where the sensing pattern configuration indicates a length for the sensing occasion based on a capability of the UE for phase coherency recovery; where the length for the sensing occasion is at least one of: a first duration based on the capability of the UE for the phase coherency recovery meeting a recovery threshold; or a second duration that is longer than the first duration based on the capability of the UE for the phase coherency recovery not meeting the recovery threshold.

Aspect 19 is the method of aspect 18, where the offset window is based on a minimum value and a maximum value that are indicated in the sensing pattern configuration, where the minimum value is based on a switching capability of the UE and is associated with an offset between the offset window and the active duration, and where the maximum value is based on a maximum time between consecutive sensing occasions at the UE.

Aspect 20 is the method of any of aspects 18 and 19, where the sensing pattern configuration indicates an extended length of at least one DRX cycle of the first DRX pattern of the network node in association with the second duration based on the capability of the UE for the phase coherency recovery not meeting the recovery threshold.

Aspect 21 is a method of wireless communication at a network node, including: configuring a sensing pattern configuration for a user equipment (UE), where the sensing pattern configuration is associated with a sensing resource for a sensing occasion and includes an offset window, where the sensing pattern configuration is further associated with (1) a first association of a first discontinuous reception (DRX) pattern of the network node with a second DRX pattern of the UE, or (2) a second association of the first DRX pattern of the network node with data communications, and where the offset window corresponds to at least one of (1) an end of an active duration for the UE prior to a first start of a next sensing occasion, (2) a second start of the active duration for the UE after a prior sensing occasion, or (3) a data communication; and transmitting, for the UE, an indication of the sensing pattern configuration.

Aspect 22 is the method of aspect 21, where the offset window is based on a minimum value and a maximum value that are indicated in the sensing pattern configuration, where the minimum value is based on a switching capability of the UE and is associated with an offset between the offset window and the active duration, and where the maximum value is based on a maximum time between consecutive sensing occasions.

Aspect 23 is the method of aspect 22, where the minimum value is set to zero or approximately zero in the sensing pattern configuration based on the switching capability of the UE indicating a capability for simultaneous processing of communication operations and sensing operations by the UE; or where the method further includes: receiving, from the UE, a capability indication that is associated with the minimum value, where the capability indication indicates at least one of first support for the simultaneous processing of the communication operations and the sensing operations or second support for the offset window based on a switching duration from the communication operations to the sensing operations.

Aspect 24 is the method of aspect 22, where an additional offset window is associated with another of the at least one of (1) the first end of the active duration at the UE prior to the first start of the next sensing occasion or (2) the second start of the active duration at the UE after the prior sensing occasion; and where the sensing pattern configuration indicates at least one of: a prior minimum value for the offset window or the additional offset window that is based on the switching capability of the UE from sensing operations to communication operations and is associated with an additional offset between the additional offset window and the active duration that is prior to the active duration; the minimum value being associated with the offset between the offset window and the active duration that is after the active duration; or the maximum value also being associated with the additional offset window.

Aspect 25 is the method of aspect 21, where the offset window is based on a minimum value indicated in at least one of the sensing pattern configuration or the data communication associated with the active duration, where the minimum value is based on a switching capability of the UE and is associated with an offset between the offset window and the data communication; where the offset corresponds to at least one of: a second end of the data communication, where the data communication includes control data in the active duration and an activation indication included in the control data, the second end of the data communication, where the data communication includes the control data in the active duration, or the second end of the data communication, where the data communication is in the active duration and includes new downlink (DL) data traffic; and where the minimum value is indicated in the sensing pattern configuration and is a first value that corresponds to the switching capability, or where the minimum value is indicated in the control data included in the data communication and is a second value that is greater than or equal to the first value.

Aspect 26 is the method of aspect 25, where the sensing resource is associated with bistatic sensing and is within the active duration, and where the sensing pattern configuration indicates at least one of: a first activity timer and a first inactivity timer that are associated with a set of DRX cycles of the first DRX pattern of the network node, where a DRX cycle of the set of DRX cycles includes the active duration and a sleep state of the UE that is after the active duration, and where the active duration is bounded according to the first activity timer, a second activity timer and a second inactivity timer that are respectively longer than the first activity timer and the first inactivity timer, where the DRX cycle includes the active duration and the sleep state of the UE that is after the active duration, and where the active duration is bounded according to the second activity timer, or a sensing timer that is based on a length of the sensing occasion, where the active duration is bounded by a first combined length of the first inactivity timer, the offset, and the sensing timer, and where an inactivity time of the active duration is bounded by a second combined length of the first inactivity timer, the offset, and the sensing timer; where the sensing resource is associated with monostatic sensing and is after the active duration during the sleep state of the UE, where a communication resource associated with the data communication in the active duration is reused as the sensing resource after the offset, and where the data communication in the active duration includes at least one of a medium access control (MAC) control element (MAC-CE) or downlink control information (DCI) that indicates the reuse of the communication resource associated with the data communication as the sensing resource; where the sensing resource is associated with the monostatic sensing and is after the active duration during the sleep state of the UE, where the offset corresponds to at least one of: a second end of the data communication, where the data communication includes the control data in the active duration and the activation indication included in the control data, the second end of the data communication, where the data communication includes the control data in the active duration, or the second end of the data communication, where the data communication is in the active duration and includes the new DL data traffic; or where the offset window included in the sensing pattern configuration corresponds to each of the second start of the active duration at the UE after the prior sensing occasion and a start of the data communication, where the offset between the offset window and the data communication is prior to the data communication.

Aspect 27 is the method of aspect 21, where the sensing occasion and the data communication are associated with an extended reality (XR) session and the data communication includes downlink (DL) XR data traffic; where the offset window is based on a minimum value associated with a switching capability of the UE, where the minimum value is indicated in the sensing pattern configuration associated with the active duration; where the minimum value is associated with an offset that is (1) after the data communication and between the offset window and the data communication, or (2) prior to the second start of the active duration at the UE that includes the data communication; and where the data communication is associated a downlink (DL) grant from the network node, where the sensing occasion is a monostatic sensing occasion, or where the sensing occasion is associated with a non-integer periodicity for the XR session; and where the non-integer periodicity is indicated in the sensing pattern configuration.

Aspect 28 is the method of any of aspects 21 to 27, where the sensing pattern configuration indicates a length for the sensing occasion based on a capability of the UE for phase coherency recovery; where the length for the sensing occasion is at least one of: a first duration based on the capability of the UE for the phase coherency recovery meeting a recovery threshold, or a second duration that is longer than the first duration based on the capability of the UE for the phase coherency recovery not meeting the recovery threshold; and where the sensing pattern configuration indicates an extended length of at least one DRX cycle of the first DRX pattern of the network node in association with the second duration based on the capability of the UE for the phase coherency recovery not meeting the recovery threshold, or where the offset window is based on a minimum value and a maximum value that are indicated in the sensing pattern configuration, where the minimum value is based on a switching capability of the UE and is associated with an offset between the offset window and the active duration, and where the maximum value is based on a maximum time between consecutive sensing occasions at the UE.

Aspect 29 is an apparatus for wireless communication including means for implementing any of aspects 1 to 20.

Aspect 30 is a computer-readable medium (e.g., a non-transitory computer-readable medium) storing computer executable code, the code when executed by at least one processor causes the at least one processor to implement any of aspects 1 to 20.

Aspect 31 is an apparatus for wireless communication at a network node. The apparatus includes a memory; and at least one processor coupled to the memory and, based at least in part on information stored in the memory, the at least one processor is configured to implement any of aspects 1 to 20.

Aspect 32 is the apparatus of aspect 31, further including at least one of a transceiver or an antenna coupled to the at least one processor.

Aspect 33 is an apparatus for wireless communication including means for implementing any of aspects 21 to 28.

Aspect 34 is a computer-readable medium (e.g., a non-transitory computer-readable medium) storing computer executable code, the code when executed by at least one processor causes the at least one processor to implement any of aspects 21 to 28.

Aspect 35 is an apparatus for wireless communication at a network node. The apparatus includes a memory; and at least one processor coupled to the memory and, based at least in part on information stored in the memory, the at least one processor is configured to implement any of aspects 21 to 28.

Aspect 36 is the apparatus of aspect 35, further including at least one of a transceiver or an antenna coupled to the at least one processor.

1. An apparatus for wireless communication at a user equipment (UE), comprising:
a memory; and
at least one processor coupled to the memory and, based at least in part on information stored in the memory, the at least one processor is configured to:
receive, from a network node, an indication of a sensing pattern configuration, wherein the sensing pattern configuration is associated with a sensing resource and includes an offset window, wherein the sensing pattern configuration is further associated with (1) a first association of a first discontinuous reception (DRX) pattern of the network node with a second DRX pattern of the UE, or (2) a second association of the first DRX pattern of the network node with data communications; and
activate the sensing resource at an activation time for a sensing occasion after a start of the offset window, wherein the offset window corresponds to at least one of (1) a first end of an active duration at the UE prior to a first start of a next sensing occasion, (2) a second start of the active duration at the UE after a prior sensing occasion, or (3) a data communication.

2. The apparatus of claim 1, wherein the offset window is based on a minimum value and a maximum value that are indicated in the sensing pattern configuration, wherein the minimum value is based on a switching capability of the UE and is associated with an offset between the offset window and the active duration, and wherein the maximum value is based on a maximum time between consecutive sensing occasions at the UE.

3. The apparatus of claim 2, wherein the minimum value is set to zero or approximately zero in the sensing pattern configuration based on the switching capability of the UE indicating a capability for simultaneous processing of communication operations and sensing operations by the UE.

4. The apparatus of claim 2, wherein the at least one processor is further configured to:
provide, for the network node, a capability indication that is associated with the minimum value, wherein the capability indication indicates at least one of first support for simultaneous processing of communication operations and sensing operations or second support for the offset window based on a switching duration from the communication operations to the sensing operations.

5. The apparatus of claim 2, wherein an additional offset window is associated with another of the at least one of (1) the first end of the active duration at the UE prior to the first start of the next sensing occasion or (2) the second start of the active duration at the UE after the prior sensing occasion; and
wherein the sensing pattern configuration indicates at least one of:
a prior minimum value for the offset window or the additional offset window that is based on the switching capability of the UE from sensing operations to communication operations and is associated with an additional offset between the additional offset window and the active duration that is prior to the active duration;
the minimum value being associated with the offset between the offset window and the active duration that is after the active duration; or
the maximum value also being associated with the additional offset window.

6. The apparatus of claim 5, wherein to activate the sensing resource at the activation time for the sensing occasion during the offset window, the at least one processor is configured to:
activate an additional sensing resource at an additional activation time for an additional sensing occasion during the additional offset window.

7. The apparatus of claim 1, wherein the offset window is based on a minimum value indicated in at least one of the sensing pattern configuration or the data communication associated with the active duration, wherein the minimum value is based on a switching capability of the UE and is associated with an offset between the offset window and the data communication.

8. The apparatus of claim 7, wherein the offset corresponds to at least one of:
a second end of the data communication, wherein the data communication includes control data in the active duration and an activation indication included in the control data;
the second end of the data communication, wherein the data communication includes the control data in the active duration; or
the second end of the data communication, wherein the data communication is in the active duration and includes new downlink (DL) data traffic.

9. The apparatus of claim 8, wherein the minimum value is indicated in the sensing pattern configuration and is a first value that corresponds to the switching capability; or
wherein the minimum value is indicated in the control data included in the data communication and is a second value that is greater than or equal to the first value.

10. The apparatus of claim 7, wherein the sensing resource is associated with bistatic sensing and is within the active duration, and wherein the sensing pattern configuration indicates at least one of:
a first activity timer and a first inactivity timer that are associated with a set of DRX cycles of the first DRX pattern of the network node, wherein a DRX cycle of the set of DRX cycles includes the active duration and a sleep state of the UE that is after the active duration, and wherein the active duration is bounded according to the first activity timer;
a second activity timer and a second inactivity timer that are respectively longer than the first activity timer and the first inactivity timer, wherein the DRX cycle includes the active duration and the sleep state of the UE that is after the active duration, and wherein the active duration is bounded according to the second activity timer; or
a sensing timer that is based on a length of the sensing occasion, wherein the active duration is bounded by a first combined length of the first inactivity timer, the offset, and the sensing timer, and wherein an inactivity time of the active duration is bounded by a second combined length of the first inactivity timer, the offset, and the sensing timer.

11. The apparatus of claim 7, wherein the sensing resource is associated with monostatic sensing and is after the active duration during a sleep state of the UE, wherein a communication resource associated with the data communication in the active duration is reused as the sensing resource after the offset, and wherein activating the sensing resource at the activation time for the sensing occasion comprises activating the sensing resource based on the monostatic sensing.

12. The apparatus of claim 11, wherein the data communication in the active duration includes at least one of a medium access control (MAC) control element (MAC-CE) or downlink control information (DCI) that indicates the reuse of the communication resource associated with the data communication as the sensing resource.

13. The apparatus of claim 7, wherein the sensing resource is associated with monostatic sensing and is after the active duration during a sleep state of the UE, wherein the offset corresponds to at least one of:
a second end of the data communication, wherein the data communication includes control data in the active duration and an activation indication included in the control data;
the second end of the data communication, wherein the data communication includes the control data in the active duration; or
the second end of the data communication, wherein the data communication is in the active duration and includes new downlink (DL) data traffic.

14. The apparatus of claim 7, wherein the offset window included in the sensing pattern configuration corresponds to each of the second start of the active duration at the UE after the prior sensing occasion and a start of the data communication, wherein the offset between the offset window and the data communication is prior to the data communication.

15. The apparatus of claim 1, wherein the sensing occasion and the data communication are associated with an extended reality (XR) session and the data communication includes downlink (DL) XR data traffic;
wherein the offset window is based on a minimum value associated with a switching capability of the UE, wherein the minimum value is indicated in the sensing pattern configuration associated with the active duration;
wherein the minimum value is associated with an offset that is (1) after the data communication and between the offset window and the data communication, or (2) prior to the second start of the active duration at the UE that includes the data communication.

16. The apparatus of claim 15, wherein the at least one processor is further configured to:
receive an image of the XR session that is included in the data communication; and
adjust or render the image included in the data communication based on the sensing occasion.

17. The apparatus of claim 16, wherein the data communication is associated a downlink (DL) grant from the network node, wherein the sensing occasion is a monostatic sensing occasion; or
wherein the sensing occasion is associated with a non-integer periodicity for the XR session, and wherein the non-integer periodicity is indicated in the sensing pattern configuration.

18. The apparatus of claim 1, wherein the sensing pattern configuration indicates a length for the sensing occasion based on a capability of the UE for phase coherency recovery;
wherein the length for the sensing occasion is at least one of:
a first duration based on the capability of the UE for the phase coherency recovery meeting a recovery threshold; or
a second duration that is longer than the first duration based on the capability of the UE for the phase coherency recovery not meeting the recovery threshold.

19. (canceled)

20. The apparatus of claim 18, wherein the sensing pattern configuration indicates an extended length of at least one DRX cycle of the first DRX pattern of the network node in association with the second duration based on the capability of the UE for the phase coherency recovery not meeting the recovery threshold.

21-28. (canceled)

29. A method of wireless communication at a user equipment (UE), comprising:
receiving, from a network node, an indication of a sensing pattern configuration, wherein the sensing pattern configuration is associated with a sensing resource and includes an offset window, wherein the sensing pattern configuration is further associated with (1) a first association of a first discontinuous reception (DRX) pattern of the network node with a second DRX pattern of the UE, or (2) a second association of the first DRX pattern of the network node with data communications; and
activating the sensing resource at an activation time for a sensing occasion after a start of the offset window, wherein the offset window corresponds to at least one of (1) a first end of an active duration at the UE prior to a first start of a next sensing occasion, (2) a second start of the active duration at the UE after a prior sensing occasion, or (3) a data communication.

30. (canceled)
